(19) United States
(12) Patent Application Publication
(10) Pub. No.: US 2023/0353717 A1
(43) Pub. Date: Nov. 2, 2023

(54) IMAGE PROCESSING SYSTEM, IMAGE PROCESSING METHOD, AND STORAGE MEDIUM

(71) Applicant: CANON KABUSHIKI KAISHA, Tokyo (JP)

(72) Inventors: HIRONAO ITO, Kanagawa (JP); Mitsuru Maeda, Tokyo (JP); MAMORU TANAE, Kanagawa (JP)

(21) Appl. No.: 18/306,055

(22) Filed: Apr. 24, 2023

(30) Foreign Application Priority Data
Apr. 27, 2022 (JP) 2022-073894
Mar. 13, 2023 (JP) 2023-038750

(51) Int. Cl. H04N 13/117; H04N 13/279; G06F 3/04817; G06T 7/70; H04N 13/383

(52) U.S. Cl. CPC H04N 13/117; H04N 13/279; G06F 3/04817; G06T 7/70; H04N 13/383; G06T 2207/30196

(57) ABSTRACT

It has been difficult to provide attractive digital content including a virtual point of view image and other images. The present disclosure is directed to providing an image processing system for providing a technique for displaying attractive digital content including a virtual point of view image and other images. Attractive digital content including a virtual point of view image and other images is displayed. The image processing system identifies a virtual point of view image and an image from a point of view different from a virtual point of view corresponding to the virtual point of view image from digital content of three-dimensional shape, and controls display of images corresponding to the virtual point of view image and the image from the point of view different from the virtual point of view corresponding to the virtual point of view image in a display area.

### BACKGROUND OF THE INVENTION

### Field of the Disclosure

The present disclosure relates to an image processing system, an image processing method, and a storage medium.

### Description of the Related Art

A technique for generating a virtual point of view image from a specified virtual point of view using a plurality of images captured by a plurality of imaging apparatuses has been attracting attention. Japanese Patent Application Laid-Open No. 2015-45920 discusses a method for capturing images of an object with a plurality of imaging apparatuses installed at difference positions, and generating a virtual point of view image using the three-dimensional shape of the object estimated from the captured images.

### SUMMARY OF THE DISCLOSURE

According to an aspect of the present disclosure an image processing system includes an identification unit configured to identify a virtual point of view image associated with a first side of digital content of three-dimensional shape and an image from a point of view different from a virtual point of view corresponding to the virtual point of view image, the image being associated with a second side of the digital content, the virtual point of view image being generated based on a plurality of images captured by a plurality of imaging apparatuses and the virtual point of view, and a display control unit configured to control display of an image corresponding to the virtual point of view image and an image corresponding to the image from the point of view different from the virtual point of view in a display area.

Further features of the present disclosure will become apparent from the following description of exemplary embodiments with reference to the attached drawings.

### BRIEF DESCRIPTION OF THE DRAWINGS

FIG. 1 is a diagram illustrating an example of a device configuration of an image processing apparatus according to a first exemplary embodiment.

FIG. 2 is a diagram illustrating a hardware configuration of the image processing apparatus according to the first exemplary embodiment.

FIG. 3 is a flowchart for describing an operation procedure of the image processing apparatus according to the first exemplary embodiment.

FIGS. 4A to 4C are diagrams illustrating examples of a three-dimensional image serving as digital content generated by a content generation unit according to the first exemplary embodiment.

FIG. 5 is a flowchart for describing an operation procedure of an image processing apparatus according to a second exemplary embodiment.

FIG. 6 is a flowchart for describing an operation procedure of an image processing apparatus according to a third exemplary embodiment.

FIG. 7 is a flowchart continued from FIG. 6.

FIG. 8 is a flowchart continued from FIGS. 6 and 7.

FIG. 9 is a diagram illustrating an example of a graphical user interface displayed on a user device according to a fourth exemplary embodiment.

FIG. 10 is a flowchart for describing an operation procedure according to the fourth exemplary embodiment.

FIG. 11 is a diagram illustrating an example of a graphical user interface displayed on a user device according to a fifth exemplary embodiment.

FIG. 12 is a flowchart for describing an operation procedure according to the fifth exemplary embodiment.

FIG. 13 is a diagram illustrating an example of a graphical user interface displayed on a user device according to a sixth exemplary embodiment.

FIG. 14 is a flowchart for describing an operation procedure according to the sixth exemplary embodiment.

FIG. 15 is a diagram illustrating an example of a device configuration of an image processing apparatus according to the seventh exemplary embodiment.

FIG. 16 is a diagram for describing the sides of digital content of three-dimensional shape according to a seventh exemplary embodiment.

FIG. 17 is a diagram for describing imaging directions of a player according to the seventh exemplary embodiment.

FIG. 18 is a diagram illustrating an example of the digital content of three-dimensional shape generated by a content generation unit according to the seventh exemplary embodiment.

FIG. 19 is a flowchart for describing an operation procedure of the image processing apparatus according to the seventh exemplary embodiment.

FIG. 20 is a flowchart for describing an operation procedure of an image processing apparatus according to an eighth exemplary embodiment.

FIG. 21 is a diagram illustrating a system configuration of an image processing system according to a ninth exemplary embodiment.

FIG. 22 is a diagram illustrating a data transmission procedure according to the ninth exemplary embodiment.

### DESCRIPTION OF THE EMBODIMENTS

Exemplary embodiments of the present disclosure will be described below with reference to the drawings. Note that the present disclosure is not limited to the following exemplary embodiments. In the drawings, similar members or elements are designated by the same reference numerals. A redundant description thereof will be omitted or simplified.

An image processing system according to a first exemplary embodiment generates a virtual point of view image seen from a specified virtual point of view based on images captured by a plurality of imaging apparatuses (cameras) in different directions, the states of the imaging apparatuses, and the virtual point of view. The virtual point of view image is displayed on the surface of a virtual three-dimensional image. The imaging apparatuses may have a functional unit for performing image processing aside from the cameras. The imaging apparatuses may have a sensor for obtaining distance information aside from the cameras.

The plurality of cameras captures images of an imaging area in a plurality of directions. An example of the imaging area is an area surrounded by a sport stadium field and a given height. The imaging area may be associated with a three-dimensional space for estimating the three-dimensional shape of an object. The three-dimensional space may cover the entire imaging area or a part of the imaging area. The imaging area may be a concert hall or a photographing studio.

The plurality of cameras is installed at respective different positions and in respective different directions (orientation) to surround the imaging area, and synchronously capture images. Note that the plurality of cameras does not need to be installed all around the imaging area. If installation places are limited, the cameras may be installed only in some directions of the imaging area. The number of cameras is not limited in particular. For example, if the imaging area is a rugby stadium, several tens to several hundreds of cameras may be installed around the field.

The plurality of cameras may include cameras having different angles of view, such as telescopic cameras and wide-angle cameras. For example, the resolution of the generated virtual point of view image can be improved by capturing images of players at high resolution using telescopic cameras. In the case of a ball game with a wide range of ball movement, the number of cameras can be reduced by capturing images using wide-angle cameras. Capturing images by combining the imaging areas of wide-angle cameras and telescopic cameras improves the degree of freedom of installation positions. The cameras are synchronized with a common time, and imaging time information is attached to each frame of the captured images.

The virtual point of view image is also called free point of view image, and enables the operator to monitor an image corresponding to a freely specified point of view. A virtual point of view image also covers the case of monitoring an image corresponding to a point of view selected by the operator from a plurality of limited point of view candidates, for example. The virtual point of view may be manually specified by the operator, or automatically specified by artificial intelligence (AI) based on image analysis results. The virtual point of view image may be a video image or a still image.

Virtual point of view information used to generate the virtual point of view image is information including the position and direction (orientation) of the virtual point of view as well as an angle of view (focal length). Specifically, the virtual point of view information includes parameters indicating the three-dimensional position of the virtual point of view, parameters indicating the direction (line of sight direction) from the virtual point of view in pan, tilt, and roll directions, and focal length information. The content of the virtual point of view information is not limited to the foregoing.

The virtual point of view information may include frame-by-frame parameters. In other words, the virtual point of view information may include parameters corresponding to each of the frames constituting a virtual point of view video image, and indicate the position and direction of the virtual point of view at respective consecutive time points.

For example, the virtual point of view image is generated by the following method. The plurality of cameras initially captures images in different directions to obtain a plurality of camera images. Next, foreground images are obtained from the plurality of camera images by extracting foreground areas corresponding to objects such as a human figure and a ball. Background images are obtained by extracting background areas other than the foreground areas. The foreground images and the background images include texture information (such as color information).

Foreground models expressing the three-dimensional shapes of the objects and texture data for coloring the foreground models are then generated based on the foreground images. Texture data for coloring a background model expressing the three-dimensional shape of the background such as a stadium is generated based on the background images. The texture data is then mapped to the foreground models and the background model, and rendering is performed based on the virtual point of view indicated by the virtual point of view information, whereby the virtual point of view image is generated.

However, the method for generating the virtual point of view image is not limited thereto. Various methods can be used, including a method for generating a virtual point of view image by projective transformation of captured images without using a foreground or background model.

A foreground image is an image obtained by extracting the area of an object (foreground area) from an image captured by a camera. The object to be extracted as a foreground area refers to a dynamic object (moving body) that moves (can change in absolute position or shape) when its images are captured in a time series in the same direction. Examples of the object include human figures in a game, such as players and judges in the game field, and if the game is a ball game, the ball. In a concert or entertainment setting, examples of the foreground object include singers, players, performers, and a master of ceremonies.

A background image is an image of an area (background area) at least different from an object to be a foreground. Specifically, a background image is a captured image from which objects to be the foreground are removed. The background may refer to an imaging object that remains stationary or substantially stationary when its images are captured in a time series in the same direction.

Examples of such an imaging object include a concert stage, a stadium where an event such as a game is held, a structure such as a goal used in a ball game, and a field. The background is an area at least different from an object to be the foreground. Imaging objects may include physical bodies other than objects and the background.

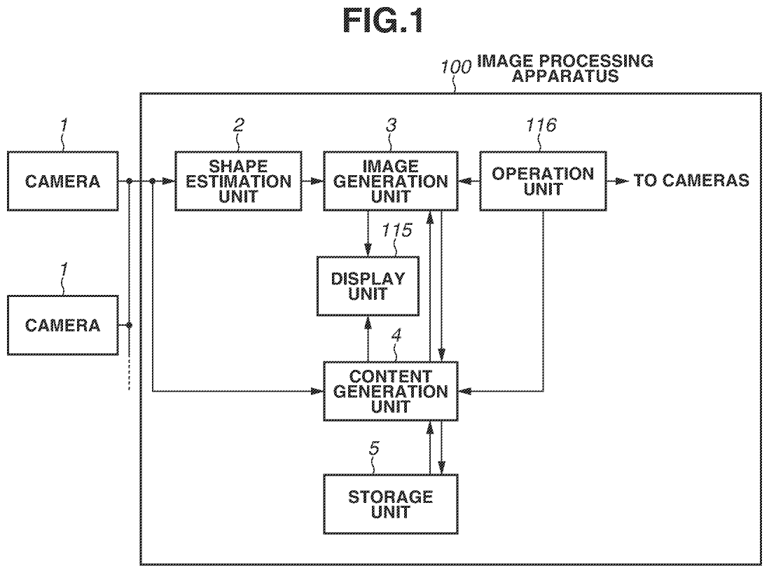

FIG. 1 is a diagram illustrating an image processing apparatus 100 according to the present exemplary embodiment. Some of the functional blocks illustrated in FIG. 1 are implemented by a computer included in the image processing apparatus 100 executing a computer program stored in a memory serving as a storage medium. However, some or all of such functional blocks may be implemented by hardware. Examples of the hardware devices include an application specific integrated circuit (ASIC) and processors (reconfigurable processor and digital signal processor [DSP]).

The functional blocks of the image processing apparatus 100 do not need to be built in the same casing, and may be configured by different devices connected via signal lines. The image processing apparatus 100 is connected with a plurality of cameras 1. The image processing apparatus 100 includes a shape estimation unit 2, an image generation unit 3, a content generation unit 4, a storage unit 5, a display unit 115, and an operation unit 116. The shape estimation unit 2 is connected to the plurality of cameras 1 and the image generation unit 3. The displays unit 115 is connected to the image generation unit 3. The functional blocks may be implemented in respective different devices. All or some of the functional blocks may be implement in the same device.

The plurality of cameras 1 is located at different positions around a concert stage, a stadium where an event such as a game is held, a structure such as a goal used in a ball game, or a field, and captures images from the respective different points of view. Each camera 1 has an identification number (camera number) for identifying the camera 1. The cameras 1 may have other functions, such as a function of extracting a foreground image from a captured image, and include hardware (such as a circuit and a device) for implementing the functions. The camera numbers may be set based on the installation positions of the cameras 1, or set based on other criteria.

The image processing apparatus 100 may be installed in the site where the cameras 1 are disposed, or outside the site like a broadcasting station. The image processing apparatus 100 is connected with the cameras 1 via a network.

The shape estimation unit 2 obtains images from the plurality of cameras 1. The shape estimation unit 2 then estimates the three-dimensional shape of an object based on the images obtained from the plurality of cameras 1. Specifically, the shape estimation unit 2 generates three-dimensional shape data expressed in a conventional mode of expression. The three-dimensional shape data may be point cloud data including points, mesh data including polygons, or voxel data including voxels.

The image generation unit 3 can obtain information indicating the position and orientation of the three-dimensional shape data on the object from the shape estimation unit 2, and generate a virtual point of view image including a two-dimensional shape expressing the object as if the three-dimensional shape of the object is seen from the virtual point of view. To generate the virtual point of view image, the image generation unit 3 can also accept virtual point of view information (such as the position of the virtual point of view and the line of sight direction from the virtual point of view) specified by the operator, and generate the virtual point of view image based on the virtual point of view information. Here, the image generation unit 3 functions as a virtual point of view image generation unit that generates a virtual point of view image based on a plurality of images obtained by a plurality of cameras.

The virtual point of view image is transmitted to the content generation unit 4. The content generation unit 4 generates, for example, digital content of three-dimensional shape as will be described below. The digital content including the virtual point of view image, generated by the content generation unit 4 is output to the display unit 115.

The content generation unit 4 can also directly receive the images from the plurality of cameras 1 and supply the images of the respective cameras 1 to the display unit 115. Moreover, the content generation unit 4 can switch which sides of the virtual three-dimensional image to display the images of the cameras 1 and the virtual point of view image based on instructions from the operation unit 116.

The display unit 115 includes a liquid crystal display and a light-emitting diode (LED), for example. The display unit 115 obtains the digital content including the virtual point of view image from the content generation unit 4, and displays the digital content. The display unit 115 also displays a graphical user interface (GUI) for the operator to operate the cameras 1.

The operation unit 116 includes a joystick, a jog dial, a touchscreen, a keyboard, and a mouse, and is used by the operator to operate the cameras 1. The operation unit 116 is also used by the operator to select images to be displayed on the surface of the digital content (three-dimensional image) generated by the content generation unit 4. The operation unit 116 can also specify the position and orientation of the virtual point of view for the image generation unit 3 to generate the virtual point of view image.

The position and orientation of the virtual point of view may be directly specified onscreen by the operator's operation instructions. Alternatively, if a predetermined object is specified onscreen by the operator's operation instructions, the predetermined object may be recognized by image recognition and tracked, and virtual point of view information from the object or virtual point of view information from a nearby position on an arc about the object may be automatically specified.

Moreover, an object satisfying a condition specified in advance by the operator's operation instructions may be recognized by image recognition, and virtual point of view information from the object or virtual point of view information from a nearby position on an arc about the object may be automatically specified. Examples of the condition specified in such a case include a specific athlete name, a player making a shoot, a player making a good play, and a ball position.

The storage unit 5 includes a memory for storing the digital content generated by the content generation unit 4, the virtual point of view image, and the camera images. The storage unit 5 may include a removable recording medium. For example, a plurality of camera images captured at other sites or on other sports scenes, virtual point of view images generated using the same, and digital content generated by combining such images may be recorded on the removable recording medium.

The storage unit 5 may be configured so that a plurality of camera images downloaded from an external server via a network, virtual point of view images generated using the same, and digital content generated by combining such images can be stored. These camera images, virtual point of view images, and digital content may be generated by a third party.

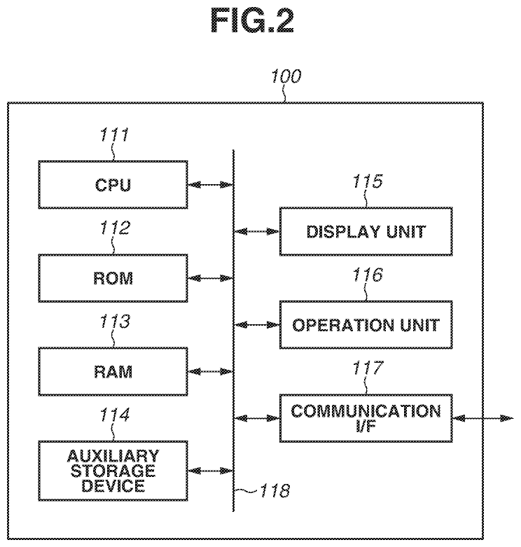

FIG. 2 is a diagram illustrating a hardware configuration of the image processing apparatus 100 according to the first exemplary embodiment. The hardware configuration of the image processing apparatus 100 will be described with reference to FIG. 2.

The image processing apparatus 100 includes a central processing unit (CPU) 111, a read-only memory (ROM) 112, a random access memory (RAM) 113, an auxiliary storage device 114, the display unit 115, the operation unit 116, a communication interface (I/F) 117, and a bus 118. The CPU 111 implements the functional blocks of the image processing apparatus 100 illustrated in FIG. 1 by controlling the entire image processing apparatus 100 using computer programs stored in the ROM 112, the RAM 113, and the auxiliary storage device 114.

The RAM 113 temporarily stores computer programs and data supplied from the auxiliary storage device 114 and data supplied from outside via the communication I/F 117. The auxiliary storage device 114 includes a hard disk drive, for example, and stores various types of data such as image data, audio data, and the digital content including the virtual point of view image from the content generation unit 4.

As described above, the display unit 115 displays the digital content including the virtual point of view image, and the GUI. The operation unit 116, as described above, receives the operator's operation input, and inputs various instructions to the CPU 111. The CPU 111 functions as a display control unit that controls the display unit 115 and an operation control unit that controls the operation unit 116.

The communication I/F 117 is used to communicate with apparatuses outside the image processing apparatus 100 (for example, the cameras 1 and external servers). For example, if the image processing apparatus 100 is connected with the external apparatuses in a wired manner, the communication cables are connected to the communication I/F 117. If the image processing apparatus 100 has the function of communicating wirelessly with the external apparatuses, the communication I/F 117 includes an antenna. The bus 118 connects the components of the image processing apparatus 100 and transmits information therebetween.

In the present exemplary embodiment, the display unit 115 and the operation unit 116 are described to be included in the image processing apparatus 100. However, at least either one of the display unit 115 and the operation unit 116 may be a separate device outside the image processing apparatus 100. The image processing apparatus 100 may be configured as a personal computer (PC) terminal, for example.

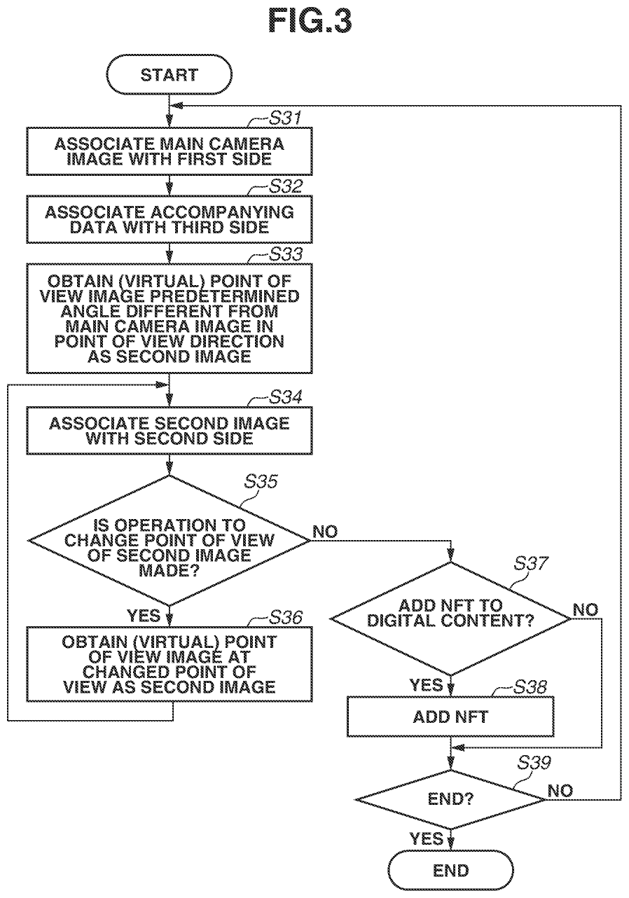

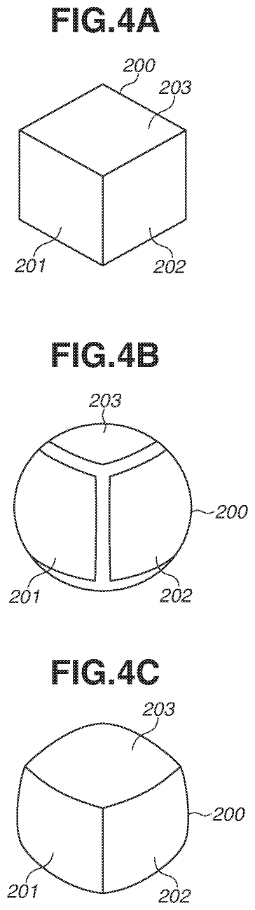

FIG. 3 is a flowchart for describing an operation procedure of the image processing apparatus 100 according to the first exemplary embodiment. FIGS. 4A to 4C are diagrams illustrating examples of the digital content of three-dimensional shape generated by the content generation unit 4 in the first exemplary embodiment.

The operation of the steps in the flowchart of FIG. 3 is performed, for example, by the CPU 111, or the computer of the image processing apparatus 100, executing computer programs stored in a memories such as the ROM 112 and the auxiliary storage device 114.

In the present exemplary embodiment, the image processing apparatus 100 may be installed in a broadcasting station, and produce and broadcast digital content 200 of three-dimensional shape illustrated in FIG. 4A. Alternatively, the image processing apparatus 100 may provide the digital content 200 via the Internet. In such a case, the image processing apparatus 100 can add a non-fungible token (NFT) to the digital content 200.

For example, to improve the asset value, the digital content 200 can be given rarity by limiting the quantity of the content to be distributed and managing the content using serial numbers. NFTs are tokens to be issued and circulated over blockchains. Examples of the NFT format include token standards called Ethereum Request for Comments (ERC)-721 and ERC-1155. Tokens are typically stored in association with a wallet managed by the operator.

In step S31, the CPU 111 associates a main camera image (first image) with a first side 201 of the digital content 200 of three-dimensional shape illustrated in FIG. 4A, for example. The CPU 111 may display the main camera image associated with the first side 201 for operator check. As illustrated in FIG. 4A, if the line of sight direction from the point of view from which the digital content 200 is virtually seen (specifically, direction perpendicular to the plane of FIG. 4A) and the normal direction of the first side 201 are not parallel, the CPU 111 may provide the following display. The main camera image displayed on the first side 201 is generated by projective transformation based on the angle of the normal direction of the first side 201 to the display plane of the digital content 200. Here, the main camera image (main image or first image) refers to an image selected for television (TV) broadcasting or other purposes from a plurality of images obtained by a plurality of cameras installed at the sports venue. The main image is an image including a predetermined object within its angle of view. The main camera image does not need to be captured by a camera installed at the sports venue. For example, the main camera image may be an image captured by a handheld camera carried in by a photographer. Alternatively, the main camera image may be an image captured by a camera or an electronic device such as a camera-equipped smartphone that is carried in by a spectator in the venue. The main camera image may be an image captured by one of the plurality of cameras 1 used to generate the virtual point of view image or an image captured by a camera not included in the plurality of cameras 1.

The image of which camera to broadcast or distribute online as the main image is selected as appropriate by the operator of the broadcasting station, using the operation unit 116. For example, if the moment of scoring is broadcast or distributed, images captured by cameras near the goals are often put on the air as the main image.

In the present exemplary embodiment, as illustrated in FIGS. 4A to 4C, the side illustrated to the left is referred to as the first side 201, the side illustrated to the right as a second side 202, and the side illustrated to the top as a third side 203. However, this is not restrictive. Which side is referred to as the first, second, or third side can be freely set in advance.

In step S32, the content generation unit 4 associates accompanying data with the third side 203 of the digital content 200. For example, data such as the name of a player who scored a goal, the name of the player's team, and the outcome of the game where the player scored a goal is associated as the accompanying data. The CPU 111 may display the accompanying data associated with the third side 203 for operator check. If an NFT is added, data indicating the rarity such as the number of NFTs issued may be displayed on the third side 203 as the accompanying data. The number of NFTs to be issued may be determined by the operator who generates the digital content 200 using an image generation system, or automatically determined by the image generation system.

In step S33, the image generation unit 3 obtains an image of which the direction of the point of view is a predetermined angle (e.g., 90°) different from that of the camera 1 capturing the main camera image and which includes, for example, a goal or a shooter from the images captured by the plurality of cameras 1. Since the layout positions and orientation of the plurality of cameras 1 are known in advance, the CPU 111 can determine from which camera the foregoing image of which the direction of the point of view is a predetermined angle different from that of the main camera image can be obtained. In the following description, the expression the point of view of an image refers to either the point of view of the camera 1 capturing the image or a virtual point of view specified to generate the image.

Alternatively, in step S33, the image generation unit 3 may obtain a virtual point of view image from a predetermined virtual point of view (for example, 90° different in the direction of the point of view as described above) where the object recognized by image recognition is included. In such a case, the image generation unit 3 may obtain the virtual point of view image by accepting a specification about the predetermined virtual point of view (90° different in the direction of the point of view, i.e., in orientation as described above) and generating the virtual point of view image.

Alternatively, the image generation unit 3 may obtain a virtual point of view image by generating virtual point of view images from a plurality of points of view in advance and selecting a corresponding one. In the present exemplary embodiment, the image of which the point of view is a predetermined angle different from that of the main camera image is described to be an image 90° different in the point of view. However, the angle can be set in advance.

The virtual point of view image may be an image corresponding to a virtual point of view identified based on the orientation of the object included in the main camera image (for example, in the case of a human figure, the direction of the face or body). If the main camera image includes a plurality of objects, the virtual point of view may be set for one of the objects or for the plurality of objects.

In the foregoing description, an image from the point of view at a predetermined angle to the main camera image is selected. However, a virtual point of view image from a predetermined point of view may be selected and obtained. Examples of the predetermined point of view include the object point of view, a point of view behind the object, and a virtual point of view at a position on an arc about the object.

The object point of view refers to a virtual point of view such that the object's position is the position of the virtual point of view and the direction of the object is the line of sight direction from the virtual point of view. Suppose, for example, that the object is a human figure. The object point of view is the point of view such that the position of the person's face is the position of the virtual point of view and the direction of the person's face is the line of sight direction from the virtual point of view. Alternatively, the line of sight direction of the person may be used as the line of sight direction from the virtual point of view.

The point of view behind the object refers to a virtual point of view such that a position a predetermined distance behind the object is the position of the virtual point of view and the direction from that position to the position of the object is the line of sight direction from the virtual point of view. Alternatively, the line of sight direction from the virtual point of view may be determined based on the direction of the object. For example, if the object is a human figure, the point of view behind the object refers to a virtual point of view such that a position a predetermined distance behind and a predetermined distance above the back of the person is the position of the virtual point of view and the direction of the person's face is the line of sight direction from the virtual point of view.

The virtual point of view at a position on an arc about the object refers to a virtual point of view such that a position on a spherical surface defined by a predetermined radius about the position of the object is the position of the virtual point of view and the direction from that position to the position of the object is the line of sight direction from the virtual point of view.

For example, if the object is a human figure, the virtual point of view is such that a position on the spherical surface defined by a predetermined radius about the position of the person is the position of the virtual point of view and the direction from that position to the position of the object is the line of sight direction from the virtual point of view.

Step S33 thus functions as a virtual point of view image generation step of obtaining a virtual point of view image from a point of view having a predetermined relationship with the first image as a second image. Here, the time (imaging timing) of the virtual point of view image from the point of view having the predetermined relationship with the first image is the same as that of the first image. In the present exemplary embodiment, the point of view having the predetermined relationship with the first image refers to one having a predetermined angular relationship or a predetermined positional relationship with the point of view of the first image as described above.

In step S34, the CPU 111 associates the second image with the second side 202 of the digital content 200. The CPU 111 may display the second image for operator check. As described above, the main image associated with the first side 201 and the second image associated with the second side 202 are synchronously controlled to be images captured at the same time. In steps S31 to S34, the first image is thus associated with the first side 201 to be described below of the digital content 200 of three-dimensional shape, and the virtual point of view image at the virtual point of view having a predetermined relationship with the first image is associated with the second side 202. Steps S31 to S34 function as a content generation step (content generation means).

In step S35, the CPU 111 determines whether an operation to change the point of view of the second image displayed on the foregoing second side 202 is made via the operation unit 116. In other words, the operator can change the point of view of the second image displayed on the second side 202 by selecting a camera image of a desired point of view from among the images captured by the plurality of cameras 1 while viewing the sport scene changing from moment to moment.

Alternatively, the operator can obtain a virtual point of view image from a desired point of view by giving the image generation unit 3 a specification about the point of view among a plurality of virtual points of view. In step S35, if such an operation to change the point of view is made (YES in step S35), the processing proceeds to step S36.

In step S36, the CPU 111 selects the point of view image from the changed point of view from among the images captured by the plurality of cameras 1 or obtains the virtual point of view image from the changed point of view from the image generation unit 3. Here, the CPU 111 may obtain a virtual point of view image generated in advance, or a new virtual point of view image generated based on the changed point of view. The processing proceeds to step S34 with the selected or obtained image as the second image. In step S34, the CPU 111 associates the second image with the second side 202. In such a state, the display unit 115 displays the first image, the second image, and the accompanying data on the first, second, and third sides 201, 202, and 203 of the digital content 200, respectively. Here, the operator can check the display for the state where the first image, the second image, and the accompanying data are associated with the first, second, and third sides 201, 202, and 203 of the digital content 200, respectively. In such a case, side numbers may also be displayed to show which side is the first side 201, the second side 202, or the third side 203.

In step S35, if the point of view is not changed (NO in step S35), the processing proceeds to step S37. In step S37, the CPU 111 determines whether to add an NFT to the digital content 200. For that purpose, the CPU 111 displays a GUI for inquiring whether to add an NFT to the digital content 200 on the display unit 115, for example. If the operator chooses to add an NFT (YES in step S37), the processing proceeds to step S38. In step S38, the CPU 111 adds the NFT to the digital content 200 and encrypts the digital content 200. The processing proceeds to step S39.

If the determination in step S37 is no (NO in step S37), the processing proceeds to step S39.

The digital content 200 in step S37 may be a three-dimensional image shaped as illustrated in FIG. 4B or 4C. If the digital content 200 has a polyhedral shape, the polyhedron is not limited to a hexahedron as illustrated in FIG. 4A, and may be an octahedron, for example.

In step S39, the CPU 111 determines whether to end the procedure for generating the digital content 200 of FIG. 3. If the operator does not operate the operation unit 116 to end the procedure (NO in step S39), the processing returns to step S31 to repeat the foregoing processing. If the operator operates the operation unit 116 to end the processing (YES in step S39), the procedure of FIG. 3 ends. If the operator does not operate the operation unit 116 to end the procedure, the processing may automatically end after a lapse of a predetermined period (for example, 30 minutes) from the last operation of the operation unit 116.

FIGS. 4B and 4C are diagrams illustrating modifications of the digital content 200. FIG. 4B illustrates a spherical version of the digital content 200 of FIG. 4A. The first image is displayed on the first side 201 that is the left spherical surface of the sphere (digital content) 200 seen from the front, for example. The second image is displayed on the second side 202 that is the right spherical surface. The foregoing accompanying data is displayed on the third side 203 that is the upper spherical surface.

FIG. 4C is a diagram illustrating an example where the flat surfaces of the digital content 200 in FIG. 4A are modified into curved surfaces having a desired curvature. The digital content 200 according to the present exemplary embodiment can thus display images using a sphere as illustrated in FIG. 4B or a cube with spherical surfaces as illustrated in FIG. 4C.

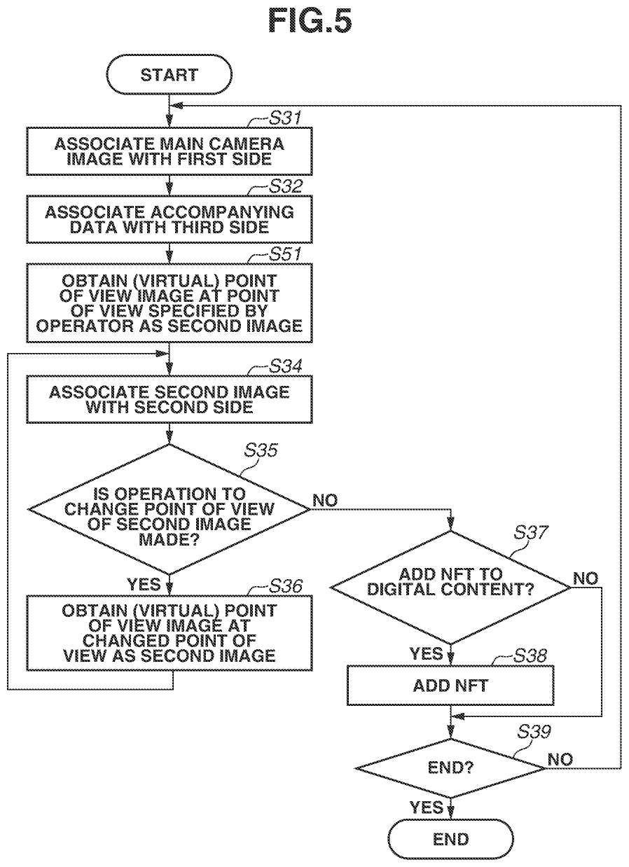

Next, a second exemplary embodiment will be described with reference to FIG. 5.

FIG. 5 is a flowchart for describing an operation procedure of an image processing apparatus 100 according to a second exemplary embodiment. The operation of the steps in the flowchart of FIG. 5 is performed, for example, by a CPU 111, or the computer of the image processing apparatus 100, executing computer programs stored in memories such as a ROM 112 and an auxiliary storage device 114.

In FIG. 5, the processing of steps having the same step numbers as in FIG. 3 is the same, and a description thereof will be omitted.

In step S51 of FIG. 5, the CPU 111 obtains a camera image from a point of view specified by the operator or a virtual point of view image from a virtual point of view specified by the operator from the image generation unit 3 as a second image. The rest of the procedure is the same as in FIG. 3.

In the first exemplary embodiment, a second image having a predetermined relationship with (a predetermined angle different from) the main image (first image) is obtained. By contrast, in the second exemplary embodiment, the second image is obtained by the operator selecting a desired camera or obtaining a virtual point of view image of a desired object from a desired point of view.

Examples of the camera image or the virtual point of view image selected by the operator in step S51 include a long shot of a sports venue from a point of view obliquely above and an image from a point of view obliquely below. In the second exemplary embodiment, the virtual point of view image to be displayed on a second side 202 can thus be selected by the operator.

The virtual point of view image selected by the operator in step S51 may be a virtual point of view image from a point of view located away from the object as if zoomed out, for example.

Camera images generated in the past and virtual point of view images generated based on the camera images may be stored in a storage unit 5, and read and displayed as the first image, the second image, and the accompanying data on the first, second, and third sides, respectively.

A step where the CPU 111 automatically switches to a default three-dimensional image display after a lapse of a predetermined period (e.g., 30 minutes) from the last operation of the operation unit 116, for example, may be inserted between steps S38 and S39. As an example of the default three-dimensional image display, the main image may be displayed on the first side, the accompanying data on the third side, and a camera image or a virtual point of view image from the most frequently used point of view in the past statistics on the second side.

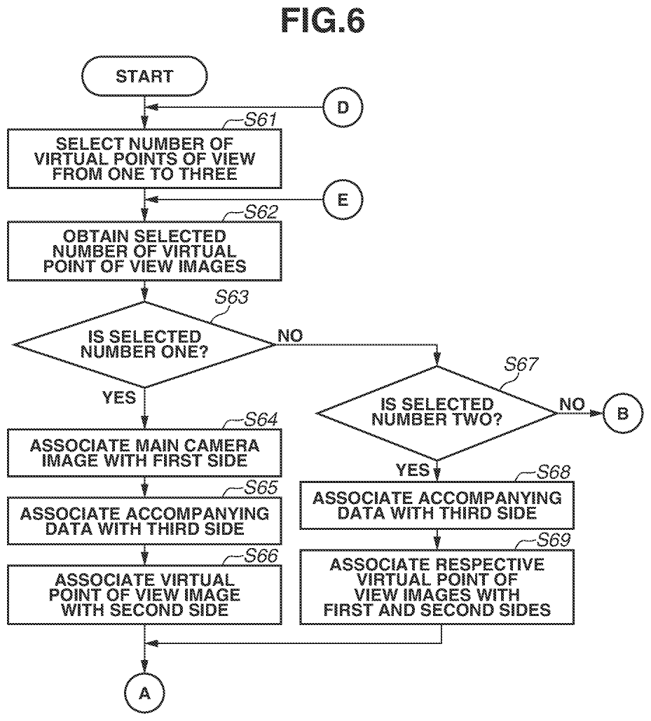

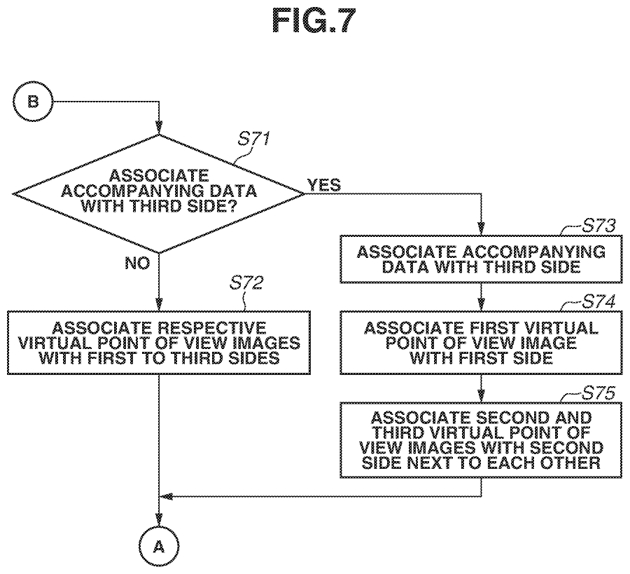

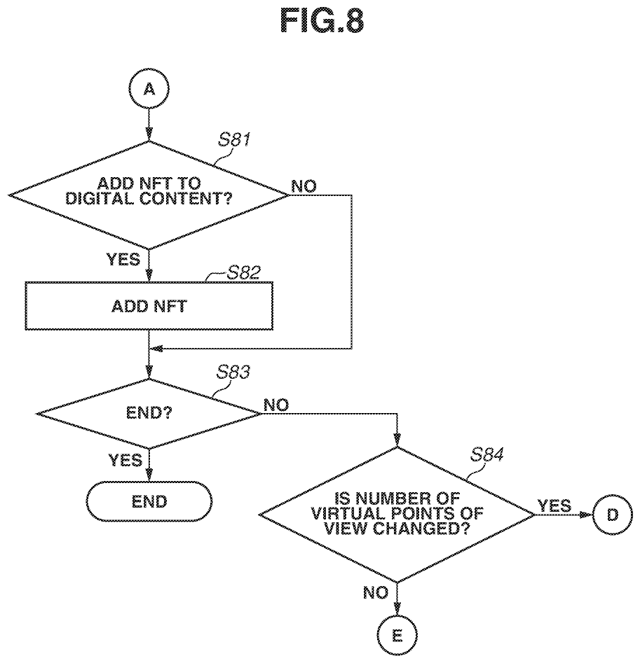

A third exemplary embodiment will be described with reference to FIGS. 6 to 8. FIG. 6 is a flowchart for describing an operation procedure of an image processing apparatus 100 according to the third exemplary embodiment. FIG. 7 is a flowchart continued from FIG. 6. FIG. 8 is a flowchart continued from FIGS. 6 and 7. The operation of the steps in the flowcharts of FIGS. 6 to 8 is performed, for example, by a CPU 111, or the computer of the image processing apparatus 100, executing computer programs stored in a memories such as a ROM 112 and an auxiliary storage device 114.

In the third exemplary embodiment, the operator selects the number of virtual points of view from one to three, and the display of first to third sides 201 to 203 of digital content 200 is automatically switched accordingly.

In step S61, the operator selects the number of virtual points of view from one to three, and the CPU 111 accepts the selected number. In step S62, the CPU 111 obtains the selected number of virtual point of view images from the image generation unit 3.

Here, the CPU 111 automatically selects representative virtual points of view. Specifically, the CPU 111 analyzes the scene, and selects the most frequently used virtual point of view in the past statistics as a first virtual point of view, for example. The CPU 111 selects the next most frequently used virtual point of view as a second virtual point of view, and the next most frequently used virtual point of view as a third virtual point of view. The second virtual point of view may be set in advance to be different from the first virtual point of view in angle by, e.g., +90°, and the third virtual point of view to be different from the first virtual point of view by, e.g., −90°. Here, +90° and −90° are just examples and not restrictive.

In step S63, the CPU 111 determines whether the selected number of virtual points of view is one. If the number is one (YES in step S63), the processing proceeds to step S64. In step S64, the CPU 111 obtains a main image from a main camera in a plurality of cameras 1, and associates the main image with the first side 201 of the digital content 200.

In step S65, the CPU 111 associates accompanying data with the third side 203 of the digital content 200. Like the accompanying data associated in step S32 of FIG. 3 according to the first exemplary embodiment, the accompanying data may be the name of a player who scored a goal, for example.

In step S66, the CPU 111 associates a first virtual point of view image from the foregoing first virtual point of view with the second side 202 of the digital content 200. The processing proceeds to step S81 of FIG. 8.

If the determination of step S63 is no (NO in step S63), the processing proceeds to step S67. In step S67, the CPU 111 determines whether the selected number of virtual points of view is two. If the number is two (YES in step S67), the processing proceeds to step S68.

In step S68, the CPU 111 associates accompanying data with the third side 203 of the digital content 200. Like the accompanying data associated in step S65, the accompanying data may be the name of a player who scored a goal, for example.

In step S69, the CPU 111 associates with the first virtual point of view image from the first virtual point of view with the first side 201 of the digital content 200. The CPU 111 also associates a second virtual point of view image from the foregoing second point of view with the second side 202 of the digital content 200. The processing proceeds to step S81 of FIG. 8.

If the determination of step S67 is no (NO in step S67), the processing proceeds to step S71 of FIG. 7. In step S71, the CPU 111 determines whether the operator chooses to associate accompanying data with the third side 203. If yes (YES in step S71), the processing proceeds to step S73. If no (NO in step S71), the processing proceeds to step S72.

In step S72, the CPU 111 associates the first virtual point of view image from the first virtual point of view with the first side 201 of the digital content 200, the second virtual point of view image from the second virtual point of view with the second side 202, and a third virtual point of view image from the third virtual point of view with the third side 203. The processing proceeds to step S81 of FIG. 8.

If the determination of step S71 is yes (YES in step S71), in step S73, the CPU 111 associates accompanying data with the third side 203 of the digital content 200. Like the accompanying data associated in step S65, the accompanying data may be the name of a player who scored a goal, for example.

In step S74, the CPU 111 associates the first virtual point of view image from the first virtual point of view with the first side 201 of the digital content 200. In step S75, the CPU 111 associates the second virtual point of view image from the second virtual point of view and the third virtual point of view image from the third virtual point of view with the second side 202 of the digital content 200 so that the second and third virtual point of view images can be displayed next to each other. In other words, the CPU 111 divides the second side 202 into two areas for displaying the second and third virtual point of view images, and associates the virtual point of view images with the respective areas. The processing proceeds to step S81 of FIG. 8.

In step S81 of FIG. 8, the CPU 111 determines whether to add an NFT to the digital content 200. For that purpose, the CPU 111 displays a GUI for inquiring whether to add an NFT to the digital content 200 on the display unit 115, for example. If the operator chooses to add an NFT (YES in step S81), the processing proceeds to step S82. In step S82, the CPU 111 adds the NFT to the digital content 200 and encrypts the digital content 200. The processing proceeds to step S83.

If the determination of step S81 is no (NO in step S81), the processing proceeds to step S83. As described above, the digital content 200 in step S81 may be shaped as illustrated in FIG. 4B or 4C.

In step S83, the CPU 111 determines whether to end the procedure of FIGS. 6 to 8. If the operator does not operate the operation unit 116 to end the procedure (NO in step S83), the processing proceeds to step S84.

In step S84, the CPU 111 determines whether the number of virtual points of view is changed.

If the number is changed (YES in step S84), the processing returns to step S61. If the number is not changed (NO in step S84), the processing returns to step S62. If the determination of step S83 is yes (YES in step S83), the procedure of FIGS. 6 to 8 ends.

The third exemplary embodiment has dealt with the case where the operator selects the number of virtual points of view from one to three, and the CPU 111 automatically selects the images to be associated with the first to third sides 201 to 203 of the digital content 200 accordingly. However, the operator may select the number of camera images to be associated with the sides constituting the digital content 200 among the images captured by the plurality of cameras 1. The CPU 111 then may automatically select predetermined cameras from the plurality of cameras 1 accordingly, and automatically associate the images captured by the selected cameras with the first to third sides 201 to 203 of the digital content 200. Note that the maximum number of points of view does not necessarily need to be three. For example, the number of points of view may be determined within the range of up to the number of sides constituting the digital content 200 or the number of sides with which images can be associated. If a plurality of images can be associated with a side, the maximum number of points of view can be further increased.

A step where the CPU 111 automatically switches to content including a default three-dimensional image display after a lapse of a predetermined period (for example, 30 minutes) from the last operation of the operation unit 116, for example, may be inserted between steps S82 and S83. As an example of the default three-dimensional image display, the first side 201 displays the main image, and the second side 202 a camera image or a virtual point of view image from the most frequently used point of view in the past statistics. The third side 203 displays the accompanying data, for example.

As described above, in the third exemplary embodiment, a virtual point of view image different from that displayed on the second side 202 can be associated with the first side 201 in steps S69, S72, and S74.

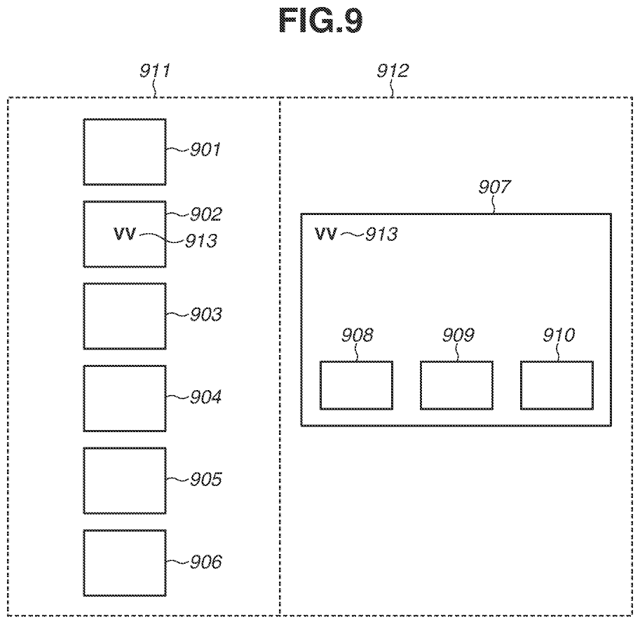

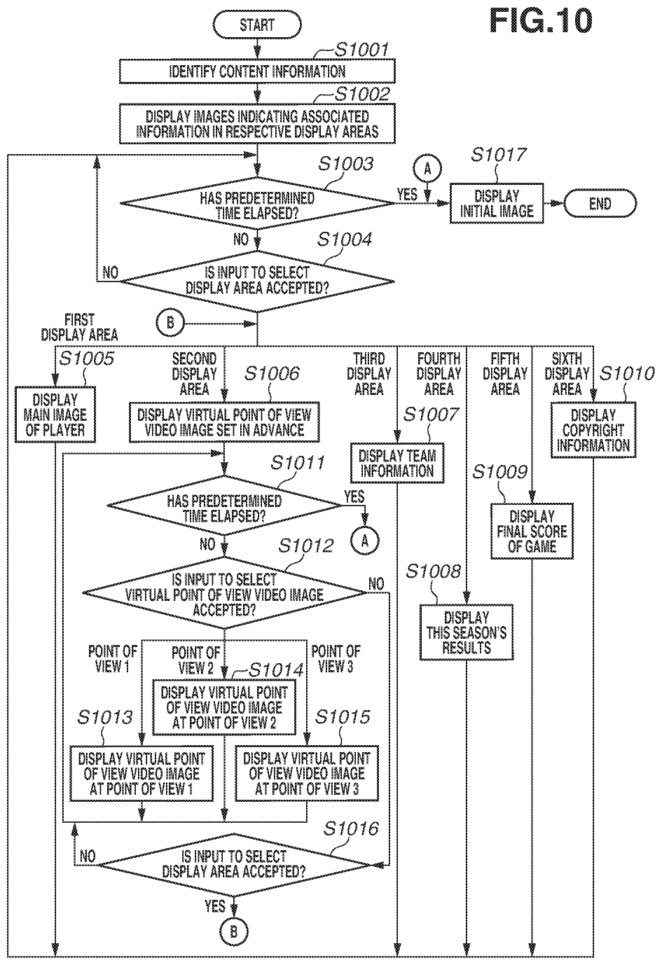

Next, a fourth exemplary embodiment will be described with reference to FIGS. 9 and 10. In the present exemplary embodiment, the system configuration is similar to that described in the first exemplary embodiment. A description thereof will thus be omitted. The hardware configuration of the system is also similar to that of FIG. 2. A description thereof will also be omitted.

The present exemplary embodiment deals with a GUI for displaying digital content of three-dimensional shape generated by the method according to any one of the first to third exemplary embodiments on a user device. Examples of the user device include a PC, a smartphone, and a tablet terminal including a touchscreen (not illustrated). The present exemplary embodiment will be described by using a tablet terminal including a touchscreen as an example. This GUI is generated by an image processing system 100 and transmitted to the user device. The GUI may be generated by the user device obtaining predetermined information.

The image processing system 100 includes a CPU, a ROM, a RAM, an auxiliary storage device, a display unit, an operation unit, a communication I/F, and a bus (not illustrated). The CPU controls the entire image processing system 100 using computer programs stored in the ROM, the RAM, and the auxiliary storage device.

The image processing system 100 identifies captured images, virtual point of view images, audio information associated with the virtual point of view images, and information about objects included in the captured images and the virtual point of view images from the digital content of three-dimensional shape.

In the present exemplary embodiment, digital content of three-dimensional shape generated according to the third exemplary embodiment, where the number of virtual points of view is three and three virtual point of view images are associated with the second side, will be described as an example. The three virtual point of view images are video images and will hereinafter be referred to as virtual point of view video images. In the present exemplary embodiment, the digital content of three-dimensional shape is a hexahedron, whereas a sphere or an octahedron may be used.

The audio information associated with the virtual point of view video images is audio information obtained in the venue during imaging. Alternatively, audio information corrected based on the virtual points of view may be used. An example of audio information corrected based on a virtual point of view is audio information that is obtained at the venue during imaging and adjusted to sound as if the viewer is at the position of the virtual point of view, facing in the line of sight direction from the virtual point of view. Audio information may be prepared separately.

FIG. 9 is a diagram illustrating a GUI according to the exemplary embodiment, displayed on the user device. The GUI image includes a first area 911 and a second area 912. The first area 911 includes a first display area 901, a second display area 902, a third display area 903, a fourth display area 904, a fifth display area 905, and a sixth display area 906 for displaying images indicating information associated with the digital content of three-dimensional shape. Each display area displays an image or information assigned thereto. The second area 912 includes a seventh display area 907 for displaying an image indicating the information associated with a display area selected by the user from the first to sixth display areas 901 to 906. The images indicating the information associated with the first to sixth display areas 901 to 906 may be still images or video images.

FIG. 9 illustrates an example where the second display area 902 associated with three virtual point of view video images is selected. If a display area associated with three virtual point of view video images is selected, a GUI 908, a GUI 909, and a GUI 910 corresponding to the virtual point of view video images of the respective points of view are displayed in the second area 912. The GUIs 908, 909, and 910 may be superimposed on the seventh display area 907.

In the present exemplary embodiment, the sides of the digital content of three-dimensional shape are associated with the display areas. In other words, the display areas display the images indicating the information associated with the respective sides of the digital content. The display areas may display images indicating information associated with the digital content regardless of the shape of the digital content.

The number of display sides of the digital content and the number of display areas can be different. For example, the user device may display only the first to fourth display areas 901 to 904 for hexahedron digital content. In such a case, the first to third display areas 901 to 903 display part of the information associated with the digital content. The fourth display area 904 displays information associated with a display area selected by the user.

Information identified from the digital content of three-dimensional shape are associated with the display areas, where images indicating the identified information are displayed. In the present exemplary embodiment, the object is a basketball player. The first display area 901 displays a main image of the player. The second display area 902 displays an image representing three virtual point of view video images related to the player displayed in the main image and an icon 913 representing a virtual point of view video image in a superimposed manner. The third display area 903 displays an image indicating information about the team with which the player displayed in the main image is affiliated. The fourth display area 904 displays an image indicating result information in the season when the main image is captured. The fifth display area 905 displays an image indicating the final score of the game during imaging. The sixth display area 906 displays an image indicating copyright information about the digital content.

If the information associated with the first to sixth display areas 901 to 906 includes information indicating a video image, a picture or icon may be superimposed on the image of the display area corresponding to the video image. In such a case, different icons are used for a video image generated from images captured by an imaging apparatus and a virtual point of view video image generated from virtual point of view images generated by a plurality of imaging apparatuses. In the present exemplary embodiment, the icon 913 is superimposed on the image representing the virtual point of view video images in the second displays area 902. If the second display area 902 is selected by the user, the icon 913 is displayed on the virtual point of view video image displayed in the second display area 907. The picture or icon may be located near the display area.

One of the first to sixth display areas 901 to 906 may be associated with a plurality of images or a plurality of video images. The present exemplary embodiment deals with the case where the second display area 902 is associated with three virtual point of view video images from different points of view. In such a case, the GUIs 908, 909, and 910 are associated with the virtual point of view video images from the respective different points of view. The GUI 908 is associated with a virtual point of view video image from the object point of view (point of view 1). The GUI 909 is associated with a virtual point of view video image corresponding to a point of view behind the object (point of view 2). The GUI 910 is associated with a virtual point of view video image from a virtual point of view located on a spherical surface about the object (point of view 3). If a plurality of images or a plurality of video images is not associated with a display area, the GUIS 908, 909, and 910 do not need to be displayed.

An initial image is set in the seventh display area 907 as information to be displayed before the user selects one of the first to sixth display areas 901 to 906. The initial image may be one of the images associated with the first to sixth display area 901 to 906, or an image different from the images associated with the first to sixth display areas 901 to 906. In the present exemplary embodiment, the main image in the first display area 901 is set as the initial image.

FIG. 10 is a flowchart for describing an operation procedure of the image processing system 100 according to the present exemplary embodiment. Specifically, FIG. 10 illustrates processing performed by the CPU 111 of FIG. 2. In step S1001, the CPU 111 identifies content information associated with the first to sixth sides of the digital content of three-dimensional shape.

In step S1002, the CPU 111 associates the content information identified in step S1001 with the first to sixth display areas 901 to 906. The CPU 111 then displays images indicating the associated information in the first to sixth display areas 901 to 906. The CPU 111 further displays the initial image set in advance in the seventh display area 907. In the present exemplary embodiment, the main image of the first display area 901 is displayed in the seventh display area 907 as the initial image.

In step S1003, the CPU 111 determines whether a predetermined time (for example, 30 minutes) has elapsed since the acceptance of the latest input. If yes (YES in step S1003), the processing proceeds to step S1017. If no (NO in step S1003), the processing proceeds to step S1004.

In step S1004, the CPU 111 determines whether the user's input to select any one of the first to sixth display areas 901 to 906 is accepted. If yes, the processing proceeds to different steps depending on the accepted input. If an input to select the first display area 901 is accepted (FIRST DISPLAY AREA in step S1004), the processing proceeds to step S1005. If an input to select the second display area 902 is accepted (SECOND DISPLAY AREA in step S1004), the processing proceeds to step S1006. If an input to select the third display area 903 is accepted (THIRD DISPLAY AREA in step S1004), the processing proceeds to step S1007. If an input to select the fourth display area 904 is accepted (FOURTH DISPLAY AREA in step S1004), the processing proceeds to step S1008. If an input to select the fifth display area 905 is accepted (FIFTH DISPLAY AREA in step S1004), the processing proceeds to step S1009. If an input to select the sixth display area 906 is accepted (SIXTH DISPLAY AREA in step S1004), the processing proceeds to step S1010. If the determination is no (NO in step S1004), the processing returns to step S1003.

In step S1005, the CPU 111 displays the main image of the player corresponding to the first display area 901 in the seventh display area 907. If the main image of the player associated with the first display area 901 is already displayed in the seventh display area 907, the processing returns to step S1003 with the main image displayed on the seventh display area 907. The same applies to steps S1007 to S1010 if the information associated with the display area selected by the user is already displayed in the seventh display area 907. A description thereof will thus be omitted. If the main image is a video image and the main image is already displayed in the seventh display area 907, the CPU 111 may reproduce the video image from a predetermined reproduction time again or simply continue to reproduce the displayed video image.

In step S1006, the CPU 111 displays the virtual point of view video image related to the player corresponding to the second display area 902 in the seventh display area 907. If a plurality of virtual point of view video images is associated with the second display area 902, the CPU 111 displays a virtual point of view video image set in advance in the seventh display area 907.

In the present exemplary embodiment, the CPU 111 displays the virtual point of view video image from the object point of view (point of view 1) in the seventh display area 907. After the display of the virtual point of view video image set in advance in the seventh display area 907, the processing proceeds to step S1011.

In step S1011, the CPU 111 determines whether a predetermined time (for example, 30 minutes) has elapsed since the acceptance of the latest input. If yes (YES in step S1011), the processing proceeds to step S1017. If no (NO in step S1011), the processing proceeds to step S1012.

In step S1012, the CPU 111 determines whether an input to select the virtual point of view video image from the user-desired virtual point of view from among the plurality of virtual point of view video images is accepted. Specifically, the CPU 111 displays the GUIs 907 to 909 representing the respective virtual points of view as in the seventh display area 907 of FIG. 9, and the user selects the virtual point of view video images of the respective virtual points of view by selecting the GUIs 907 to 909. If the determination is yes, the processing proceeds to a next step depending on the selected GUI. If the GUI 908 is selected (POINT OF VIEW 1 in step S1012), the processing proceeds to step S1013. If the GUI 909 is selected (POINT OF VIEW 2 in step S1012), the processing proceeds to step S1014. If the GUI 910 is selected (POINT OF VIEW 3 in step S1012), the processing proceeds to step S1015.

If the determination is no (NO in step S1012), the processing proceeds to step S1016.

The virtual point of view video images from the respective points of view may be selected by a flick operation or a touch operation on the seventh display area 907 without providing the GUIs 908 to 910 representing the respective virtual points of view. If a plurality of virtual point of view video images is associated with the second display area 902, the plurality of virtual point of view video images may be connected into a virtual point of view video image for continuous playback. In such a case, the processing skips step S1012 and proceeds to S1016.

In step S1013, the CPU 111 displays the virtual point of view video image from the object point of view (point of view 1) in the seventh display area 907. The processing returns to step S1011. If the virtual point of view video image from the object point of view is already displayed in the seventh display area 907, the CPU 111 may reproduce the video image from a predetermined reproduction time again or simply continue to reproduce the displayed video image. The same applies to steps S1014 and S1015 if the intended virtual point of view video image is already displayed in the seventh display area 907. A description thereof will thus be omitted.

In step S1014, the CPU 111 displays the virtual point of view video image corresponding to the point of view behind the object (point of view 2) in the seventh display area 907. The processing returns to step S1011.

In step S1015, the CPU 111 displays the virtual point of view video image from the virtual point of view located on the spherical surface about the object (point of view 3) in the seventh display area 907. The processing returns to step S1011.

In step S1016, the CPU 111 determines whether the user's input to select any one of the first to sixth display areas 901 to 906 is accepted. If yes, the processing branches as in step S1004. If no (NO in step S1016), the processing returns to step S1011.

In step S1007, the CPU 111 displays the information about the team with which the player is affiliated corresponding to the third display area 903 in the seventh direction area 907.

In step S1008, the CPU 111 displays information about this season's results of the player corresponding to the fourth display area 904 in the seventh direction area 907.

In step S1009, the CPU 111 displays the final score of the game corresponding to the fifth display area 905 in the seventh display area 907.

In step S1010, the CPU 111 displays the copyright information corresponding to the sixth display area 906 in the seventh display area 907.

In step S1017, the CPU 111 displays the initial image in the seventh display area 907. In the present exemplary embodiment, the CPU 111 displays the main image of the first display area 901 in the seventh display area 907 as the initial image. The processing ends.

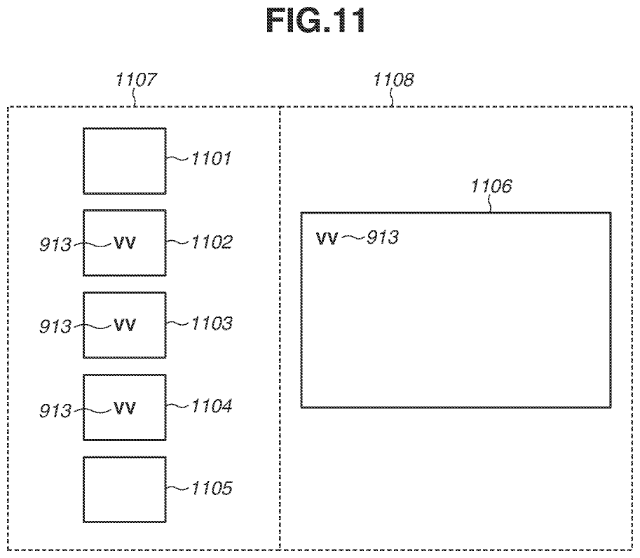

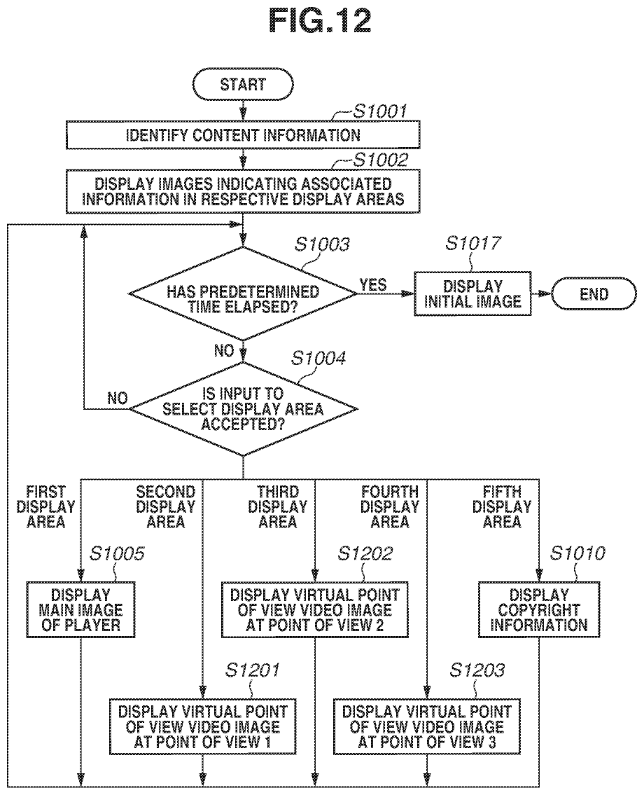

Next, a fifth exemplary embodiment will be described with reference to FIGS. 11 and 12. In the present exemplary embodiment, the system configuration is similar to that described in the first exemplary embodiment. A description thereof will thus be omitted. The hardware configuration of the system is also similar to that of FIG. 2, and a description thereof will also be omitted.

FIG. 11 is a diagram illustrating a GUI according to the present exemplary embodiment. Like the fourth exemplary embodiment, digital content of three-dimensional shape generated according to the third exemplary embodiment, where the number of virtual points of view is three and three virtual point of view images are associated with a second side, will be described as an example.

Unlike the fourth exemplary embodiment, the number of display areas displayed in a first area 1107 is different from the number of sides of the digital content. Specifically, the number of display areas displayed in the first area 1107 is five and the number of sides of the digital content is six. This GUI is generated by an image processing system 100 and transmitted to a user device. Alternatively, the GUI may be generated by the user device obtaining predetermined information.

In the present exemplary embodiment, the digital content includes three virtual point of view video images from different points of view. The virtual point of view video images from the respective points of view are associated with a second display area 1102 to a fourth display area 1104. Like the fourth exemplary embodiment, the three virtual points of view are an object point of view (point of view 1), a point of view behind the object (point of view 2), and a virtual point of view located on a spherical surface about the object (point of view 3). Since the three virtual point of view video images are associated with the second to fourth display areas 1102 to 1104, ions 913 representing a virtual point of view image are superimposed on the second to fourth display areas 1102 to 1104.

A first display area 1101 is associated with a main image of a player. A fifth display area 1105 is associated with copyright information. The information to be displayed in the display areas is not limited thereto, and any information associated with the digital content can be displayed.

FIG. 12 is a flowchart for describing an operation procedure of the image processing apparatus 100 according to the present exemplary embodiment. The operation of the steps in the flowchart of FIG. 12 is performed, for example, by a CPU 111, or the computer of the image processing apparatus 100, executing computer programs stored in memories such as a ROM 112 and an auxiliary storage device 114. In FIG. 12, the processing of steps having the same step numbers as in FIG. 10 is the same. A description thereof will be omitted.

In step S1004 of FIG. 12, if an input to select the second display area 1102 is accepted (SECOND DISPLAY AREA in step S1004), the processing proceeds to step S1201. If an input to select the third display area 1103 is accepted (THIRD DISPLAY AREA in step S1004), the processing proceeds to step S1202. If an input to select the fourth display area 1104 is accepted (FOURTH DISPLAY AREA in step S1004), the processing proceeds to step S1203.

In step S1201, the CPU 111 displays the virtual point of view video image from the object point of view (point of view 1) in a sixth display area 1106. The processing returns to step S1003.

In step S1202, the CPU 111 displays the virtual point of view video image corresponding to the point of view behind the object (point of view 2) in the sixth display area 1106. The processing returns to step S1003.

In step S1203, the CPU 111 displays the virtual point of view video image from the virtual point of view located on the spherical surface about the object (point of view 3) in the sixth display area 1106. The processing returns to step S1003.

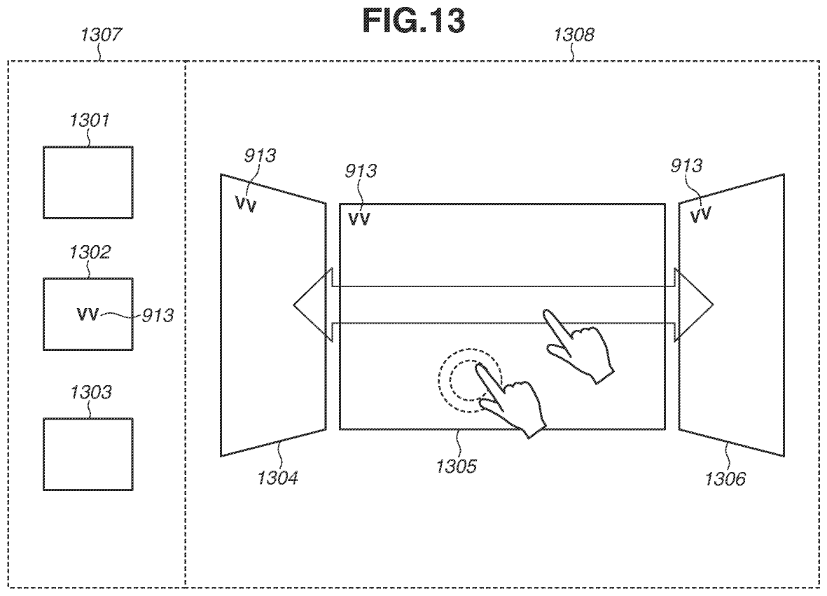

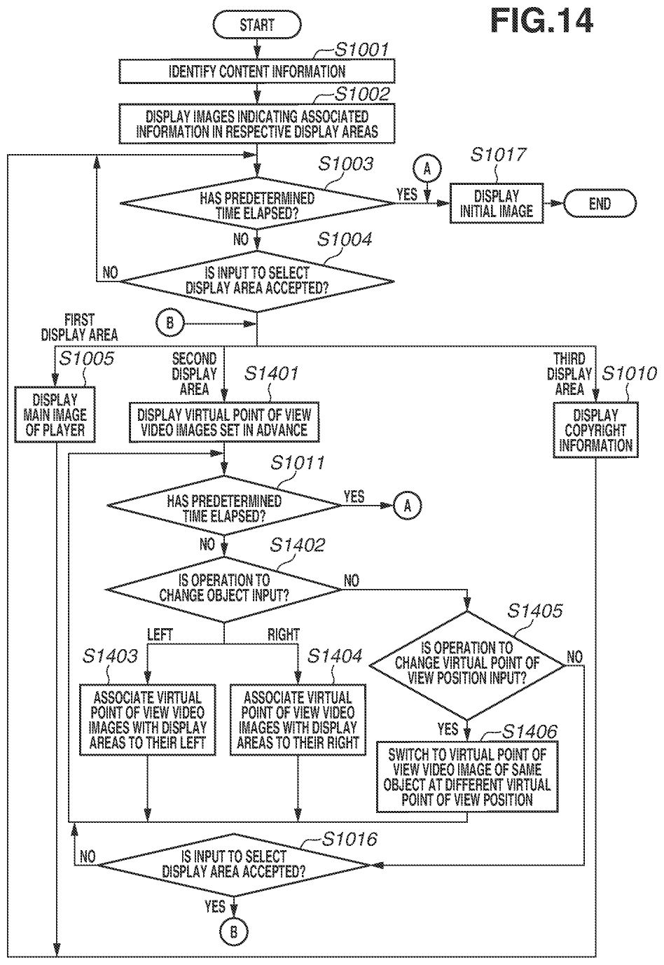

Next, a sixth exemplary embodiment will be described with reference to FIGS. 13 and 14. In the present exemplary embodiment, the system configuration is similar to that described in the first exemplary embodiment. A description thereof will thus be omitted. The hardware configuration of the system is also similar to that of FIG. 2, and a description thereof will also be omitted.

FIG. 13 is a diagram illustrating a GUI according to the sixth exemplary embodiment. In the present exemplary embodiment, digital content of three-dimensional shape generated according to the third exemplary embodiment, where the number of virtual points of view is six and six virtual point of view video images are associated with a second side, will be described as an example. The six virtual point of view images are video images, and will hereinafter be referred to as virtual point of view video images. The GUI is generated by an image processing system 100 and transmitted to a user device. Alternatively, this GUI may be generated by the user device obtaining predetermined information.

Unlike the fourth exemplary embodiment, in the present exemplary embodiment, the number of display areas displayed in a first area 1307 is different from the number of sides of the digital content. Specifically, the number of display areas displayed in the first area 1307 is three and the number of sides of the digital content is six. Six virtual point of view video images are associated with a second display area 1302.

A first display area 1301 is associated with a main image of a player. A third display area 1303 is associated with copyright information. The information to be displayed in the display areas is not limited thereto, and any information associated with the digital content can be displayed.

Unlike the fourth and fifth exemplary embodiments, in the present exemplary embodiment, a second area 1308 includes a fourth display area 1304, a fifth display area 1305, and a sixth display area 1306. If any one of the first to third display areas 1301 to 1303 is selected by the user, the image corresponding to the selected display area is displayed in the fifth display area 1305.

The fifth display area 1305 is constantly displayed in the second area 1308. By contrast, the fourth display area 1304 and the sixth display area 1306 are displayed in the second area 1308 if a virtual point of view video image is displayed in the fifth display area 1305.

The display area located at the center of the second area 1308 and the other display areas are different in shape. Specifically, the fourth and sixth display areas 1304 and 1306 have a different shape and size from those of the fifth display area 1305. In the present exemplary embodiment, the fifth display area 1305 has a rectangular shape, and the fourth and sixth display areas 1304 and 1306 a trapezoidal shape. This can improve the viewability of the fifth display area 1305 located at the center of the second area 1308.

The six virtual point of view video images have respective different virtual points of view. There are three objects, and the six virtual point of view video images include three having a virtual point of view located at each of the three objects, and three having a virtual point of view located a certain distance behind and a certain distance above the position of each of the three objects. For example, in a basketball game where the objects are an offensive player A, a defensive player B, and the basketball, the six virtual point of view video images are the following: a first virtual point of view video image with the position of the player A's face as the position of the virtual point of view and the direction of the player A's face as the line of sight direction from the virtual point of view; a second virtual point of view video image with a position a certain distance behind (for example, 3 m behind) and a certain distance above (for example, 1 m above) the position of the player A's face as the position of the virtual point of view and a direction set to include the player A within the angle of view as the line of sight direction from the virtual point of view; a third virtual point of view video image with the position of the player B's face as the position of the virtual point of view and the direction of the player B's face as the line of sight direction from the virtual point of view; a fourth virtual point of view video image with a position a certain distance behind and a certain distance above the position of the player B's face as the position of the virtual point of view and a direction set to include the player B within the angle of view as the line of sight direction from the virtual point of view; a fifth virtual point of view video image with the barycentric position of the basketball as the position of the virtual point of view and the traveling direction of the basketball as the line of sight direction from the virtual point of view; and a sixth virtual point of view video image with a position a certain distance behind and certain distance above the barycentric position of the basketball as the position of the virtual point of view and the traveling direction of the basketball as the line of sight direction from the position of the virtual point of view.

A position a certain distance behind and a certain distance above the position of an object may be determined based on the imaging scene, or determined based on the proportion of the object to the angle of view of the virtual point of view video image. The line of sight direction from a virtual point of view is set based on at least one of the following: the orientation of the object, the traveling direction of the object, and the position of the object in the angle of view.

In the present exemplary embodiment, the six virtual point of view video images have the same playback duration. However, the virtual point of view video images may have different playback durations.

If the second display area 1302 corresponding to the six virtual point of view video images is selected, the fourth and sixth display areas 1304 and 1306 are displayed in the second area 1308 in addition to the fifth display area 1305. The three display areas 1304, 1305, and 1306 displayed in the second area 1308 are associated with the virtual point of view video images of the respective three objects. Specifically, the fourth display area 1304 is associated with the first and second virtual point of view video images including the player A as the object. The fifth display area 1305 is associated with the third and fourth virtual point of view video images including the player B as the object. The sixth display area 1306 is associated with the fifth and sixth virtual point of view video images including the basketball as the object.

All the video images displayed in the display areas are not reproduced at the same time. Only the video image displayed in the display area located at the center of the second area 1308 is reproduced. In the present exemplary embodiment, only the virtual point of view video image displayed in the fifth display area 1305 is reproduced.

FIG. 14 is a flowchart for describing an operation procedure of the image processing apparatus 100 according to the sixth exemplary embodiment. The operation of the steps in the flowchart of FIG. 14 is performed, for example, by a CPU 111, or the computer of the image processing apparatus 100, executing computer programs stored in memories such as a ROM 112 and an auxiliary storage device 114. In FIG. 14, the processing of steps having the same step numbers as in FIG. 10 is the same. A description thereof will be omitted.

In step S1401, the CPU 111 displays the virtual point of view video images set in advance in the fourth, fifth, and sixth display areas 1304, 1305, and 1306. In the present exemplary embodiment, the three virtual point of view video images with the positions of the three objects as those of the virtual points of view are displayed. Specifically, the fourth display area 1304 displays the first virtual point of view video image with the position of the player A's face as the position of the virtual point of view.

The fifth display area 1305 displays the third virtual point of view video image with the position of player the B's face as the position of the virtual point of view. The sixth display area 1306 displays the fifth virtual point of view video image with the barycentric position of the basketball as the position of the virtual point of view. Here, only the fifth display area 1305 located at the center of the second area 1308 reproduces the video image, and the fourth and sixth display areas 1304 and 1306 do not. After the display of the virtual point of view video images set in advance in the fourth, fifth, and sixth display area 1304, 1305, and 1306, the processing proceeds to step S1011.

In step S1402, the CPU 111 determines whether an operation to change the object in the virtual point of view video image displayed in the fifth display area 1305 is input. Specifically, the CPU 111 determines whether an operation to switch to the virtual point of view video image of another object is input by a horizontal slide operation on the fifth display area 1305. If the determination is yes, the processing proceeds to a next step depending on the sliding direction. If input information about a leftward slide operation is accepted (LEFT in step S1402), the processing proceeds to step S1403. If input information about a rightward slide operation is accepted (RIGHT in step S1402), the processing proceeds to step S1404. If the determination is no (NO in step S1402), the processing proceeds to step S1405.

In step S1403, the CPU 111 reassociates the virtual point of view video images associated with the respective display areas with the display areas to their left. For example, if a leftward slide operation on the third virtual point of view video image corresponding to the fifth display area 1305 is accepted, the third and fourth virtual point of view video images corresponding to the fifth display area 1305 are associated with the fourth display area 1304 on the left of the fifth display area 1305. The fifth and sixth virtual point of view video images associated with the sixth display area 1306 are associated with the fifth display area 1305 on the left of the sixth display area 1306. In the second area 1308, there is no display area on the left of the fourth display area 1304. The first and second virtual point of view video images corresponding to the fourth display area 1304 are therefore associated with the sixth display area 1306 having no display area on the right. After the reassociation, the CPU 111 reproduces one of the virtual point of view video images associated with the fifth display area 1305 where the position of the virtual point of view with respect to the object is the same as in the virtual point of view video image reproduced in the fifth display area 1305 before the reassociation. For example, if the virtual point of view video image reproduced in the fifth display area 1305 before the reassociation is the third virtual point of view video image, the fifth and sixth virtual point of view video images are associated with the fifth display area 1305 after the reassociation. Since the third virtual point of view video image is a virtual point of view video image with the position of the object as the position of the virtual point of view, the fifth virtual point of view video image that also is a virtual point of view video image with the position of the object as the position of the virtual point of view is displayed in the fifth display area 1305. The user can thus intuitively switch the virtual point of view video images of different objects. After the foregoing processing, the processing returns to step S1011.

In step S1404, the CPU 111 reassociates the virtual point of view video images associated with the respective display areas with the display areas to their right. For example, if a rightward slide operation on the third virtual point of view video image corresponding to the fifth display area 1305 is accepted, the third and fourth virtual point of view video images corresponding to the fifth display area 1305 are associated with the sixth display area 1306 on the right of the fifth display area 1305. The first and second virtual point of view video images associated with the fourth display area 1304 are associated with the fifth display area 1305 on the right of the fourth display area 1304. In the second area 1308, there is no display area on the right of the sixth display area 1306. The fifth and sixth virtual point of view video images corresponding to the fifth display area 1306 are therefore associated with the fourth display area 1304 having no display area on the left. After the reassociation, the CPU 111 reproduces one of the virtual point of view video images associated with the fifth display area 1305 where the position of the virtual point of view with respect to the object is the same as in the virtual point of view video image reproduced in the fifth display area 1305 before the reassociation. After the foregoing processing, the processing returns to step S1101.

In step S1405, the CPU 111 determines whether an operation to change the position of the virtual point of view of the virtual point of view video image displayed in the fifth display area 1305 is input. Specifically, the CPU 111 accepts an operation to switch to the virtual point of view video image of the same object with a different virtual point of view position by a double-tap operation on the fifth display area 1305. If yes (YES in step S1405), the processing proceeds to step S1406. If no (NO in step S1405), the processing proceeds to step S1016.

In step S1406, the CPU 111 performs processing for changing the position of the virtual point of view of the virtual point of view video image. Specifically, the CPU 111 switches to the virtual point of view video image of the same object with a different virtual point of view position. Suppose, for example, that the fifth display area 1305 is associated with the third virtual point of view video image with the position of the player B's face as the position of the virtual point of view and the fourth virtual point of view video image with the position a certain distance behind and a certain distance above the position of the player B's face as the position of the virtual point of view. If the third virtual point of view video image is displayed in the fifth display area 1305 when a double-tap operation is accepted, the CPU 111 performs processing for switching to the fourth virtual point of view video image and displaying the fourth virtual point of view video image in the fifth display area 1305. In such a manner, the user can intuitively switch the positions of the virtual points of view of the same object. After the above processing, the processing returns to step S1011.

In switching the virtual point of view video images by a slide operation or a double-tap operation, the timecode of the virtual point of view video image being reproduced in the fifth display area 1305 may be recorded, and the switched virtual point of view video image may be reproduced from the time indicated by the recorded timecode.

In the present exemplary embodiment, the positions of the virtual point of view of the same object are switched by a double-tap operation. However, other operations may be used. For example, the positions of the virtual point of view may be switched by a pinch-in operation, a pinch-out operation, or a vertical slide operation on the fifth display area 1305.

In the present exemplary embodiment, a plurality of virtual point of view video images of the same object is associated with a display area. However, a plurality of virtual point of view video images of the same object may be associated with a plurality of display areas. Specifically, a seventh display area, an eighth display area, and a ninth display area (not illustrated) may be added above the fourth display area 1304, the fifth display area 1305, and the sixth display area 1306, respectively. In such a case, the fourth display area 1304 displays the first virtual point of view video image, the fifth display area 1305 the third virtual point of view video image, the sixth display area 1306 the fifth virtual point of view video image, the seventh display area the second virtual point of view video image, the eighth display area the fourth virtual point of view video image, and the ninth display area the sixth virtual point of view video image. In the sixth exemplary embodiment, the operation to switch virtual point of view video images of the same object is performed by a tap gesture. In this modification, the display areas can be switched by a vertical slide operation. The user can thus intuitively operate the virtual point of view.

In the first exemplary embodiment, a second image having a predetermined relationship with the main image (first image) associated with the first side 201 of the digital content 200 is associated with the second side 202 of the digital content 200. In the present exemplary embodiment, a plurality of virtual point of view video images having the same timecode is associated with the respective sides of digital content of three-dimensional shape. Specifically, an example of associating the virtual point of view video images with the respective sides of the digital content of three-dimensional shape based on line of sight directions from respective virtual points of view to an object will be described.

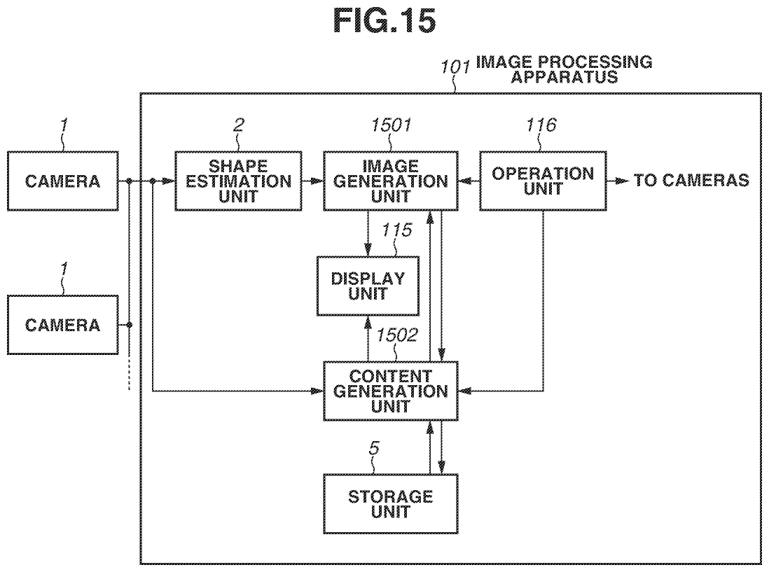

FIG. 15 is a diagram illustrating an image processing system according to the present exemplary embodiment. Similar blocks to those of FIG. 1 are designated by the same reference numerals, and a description thereof will be omitted.

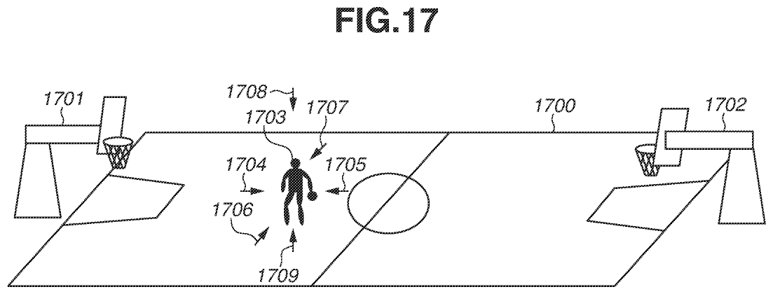

An image generation unit 1501 analyzes correspondence of the position of a virtual point of view specified by the operation unit 116 and a line of sight direction from the virtual point of view with the coordinates of objects displayed in the virtual point of view video image, based on the virtual point of view and coordinate information about the objects. The image generation unit 1501 identifies an object of interest from the virtual point of view video image seen from the virtual point of view specified by the operation unit 116. In the present exemplary embodiment, the image generation unit 1501 identifies an object at or closest to the center of the virtual point of view video image. However, this is not restrictive. For example, an object accounting for the highest proportion in the virtual point of view video image may be identified. An object may be selected without generating a virtual point of view image. Next, the image generation unit 1501 determines imaging directions to capture an image of the identified object of interest in, and generates a plurality of virtual points of view corresponding to the respective imaging directions. The imaging directions are top, bottom, left, right, and front and back (front and rear). The plurality of virtual points of view to be generated is associated with the same timecode as that of the virtual point of view specified by an operator. After the generation of the virtual point of view video images corresponding to the generated virtual points of view, the image generation unit 1501 determines in which of the imaging directions, top, bottom, left, right, front, or back, each of the virtual point of view video images of the object of interest is captured, and attaches imaging direction information to the virtual point of view video image. The imaging direction information is information indicating in which direction the video image is captured with respect to the direction of the object of interest. The imaging direction is determined on the basis of the positional relationship between the main object in the virtual point of view video image and a predetermined position at the beginning of capturing the virtual point of view video image. Details will be described with reference to FIG. 17.

A content generation unit 1502 determines which side of a digital content of three-dimensional shape to associate the virtual point of view video images received from the image generation unit 1501 with, on the basis of the imaging direction information attached to the virtual point of view video images, and generates the digital content of three-dimensional shape.

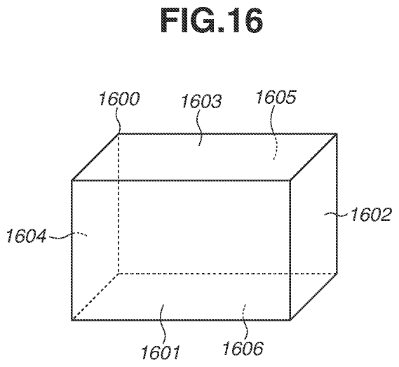

FIG. 16 is a diagram for describing sides of the digital content of three-dimensional content according to the present exemplary embodiment. A side 1601 of digital content 1600 of three-dimensional shape will be defined as a front side, a side 1602 as a right side, a side 1603 as a top side, a side 1604 as a left side, a side 1605 as a rear side, and a side 1606 as a bottom side.

FIG. 17 is a diagram for describing the imaging directions of a player. A basket 1701, a basket 1702, and a player 1703 are on a court 1700. The player 1703 attacks towards the basket 1701. Here, the direction connecting the player 1703 and the basket 1701 horizontally from the basket 1701 to the player 1703 will be defined as a “front side” direction. The method for determining the front side direction will now be described. A line segment connecting the player 1703 and the basket 1701 is initially derived, assuming that the basket 1701 is at a predetermined point and the player 1703 is at the barycenter of his/her three-dimensional (3D) model. Next, a plane orthogonal to the derived line segment and tangential to the 3D model of the player 1703 is derived as a front side. The line segment connecting the player 1703 and basket 1701 is derived in advance, but it is not limited to this. For example, a ray of light is sent from the predetermined point corresponding to basket 1701 toward the barycenter of his/her 3D model of the player 1703. Then, the plane perpendicular to the ray of light with the intersection of the ray of light and the 3D model as the center is derived as a front side. After the front side is determined, a bounding box surrounding the player 1703 is determined. The top side, a bottom side, a right side, a left side, and a rear side are determined with reference to the front side of the bounding box. In FIG. 17, the direction in which the player 1703 is seen from the front side is expressed by an arrow 1704. The imaging direction information about the virtual point of view video image generated with this direction as the line of sight direction from the virtual point of view is “front side”. The virtual point of view video image to which the imaging direction information “front side” is attached is associated with the side 1601 of FIG. 16. Similarly, the imaging direction information about the virtual point of view video image generated with the direction of an arrow 1706 in which the player 1703 is seen from the right as the line of sight direction from the virtual point of view is “right side”. The virtual point of view video image to which the imaging direction information “right side” is attached is associated with the side 1602 of FIG. 16. The imaging direction information about the virtual point of view video image generated with the direction of an arrow 1707 in which the player 1703 is seen from the left as the line of sight direction from the virtual point of view is “left side”. The virtual point of view video image to which the imaging direction information “left side” is attached is associated with the side 1604 of FIG. 16. The imaging direction information about the virtual point of view video image generated with the direction of an arrow 1708 in which the player 1703 is seen from above as the line of sight direction from the virtual point of view is “top side”. The virtual point of view video image to which the imaging direction information “top side” is attached is associated with the side 1603 of FIG. 16. The imaging direction information about the virtual point of view video image generated with the direction of an arrow 1709 in which the player 1703 is seen from below is “bottom side”. The virtual point of view video image to which the imaging direction information “bottom side” is attached as the line of sight direction from the virtual point of view is associated with the side 1606 of FIG. 16. The imaging direction information about the virtual point of view video image generated with the direction of an arrow 1705 in which the player 1703 is seen from behind is “rear side”. The virtual point of view video image to which the imaging direction information “rear side” is attached is associated with the side 1605 of FIG. 16. In the present exemplary embodiment, the directions are determined with reference to the relationship between the player 1703 and the basket 1701 at a specific moment. However, the directions may be changed in accordance with the positional relationship between the player 1703 and the basket 1701 as the player 1701 moves in the court.

In the present exemplary embodiment, the imaging directions are determined in accordance with the positions of a player and a basket. However, this is not restrictive. For example, the direction in which the player is seen along the traveling direction of the player is set as the “front side” direction. Directions obtained by rotating the “front side” direction±90° on the XY plane are set as the “left side” and “right side” directions. Directions obtained by rotating the “front side” direction by ±90° on the YZ plane are set as the “top side” and “bottom side” directions. A direction obtained by rotating the “front side” direction by +180° or −180° on the XY plane is set as the “rear side” direction. As another example of the setting of the front side, the direction in which the player faces may be set as the “front side” direction. The direction seen from the position of the basket closer to a straight line along the traveling direction of the player may be set as the “front side” direction.

The imaging directions may be changed depending on the positional relationship with the basket each time the player moves. For example, the front side may be determined again when the player moves by a certain distance (for example, 3 m) or more from the position where the front side is determined in advance. The imaging directions may be changed after a lapse of a certain time. The front side may be determined again if a comparison between the initially determined front side and the front side calculated after a movement shows an angular change of 45° or more in a plan view. With timing when the ball is passed to another player as a trigger, the front side may be redetermined each time in accordance with the positional relationship between the player receiving the pass and the basket.

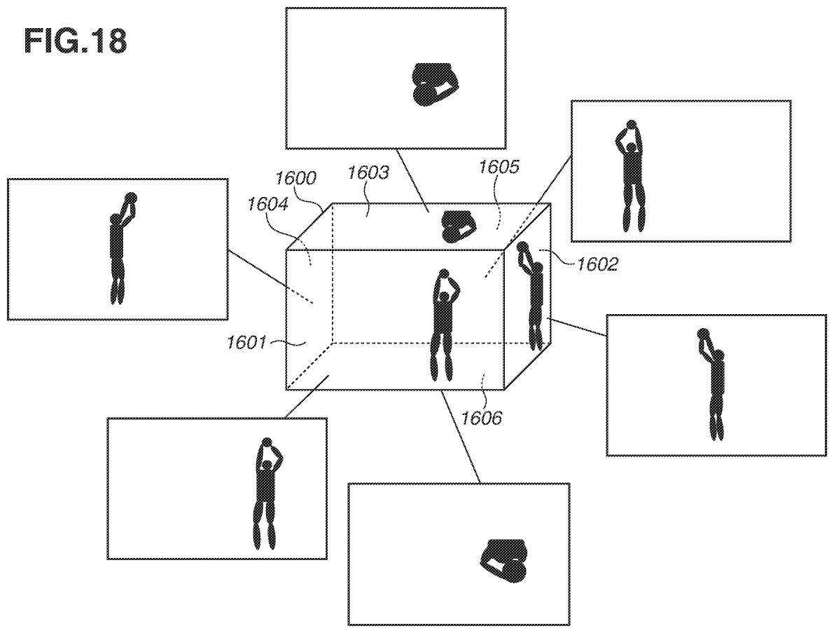

FIG. 18 is a diagram illustrating an example of the digital content of 3D shape generated by the content generation unit 4. A plurality of virtual point of view video images seen from a plurality of virtual points of view corresponding to the same timecode as that of the virtual point of view set by the operator is associated with the respective sides of the digital content of 3D shape. Such display enables a user to intuitively find out from which positions the virtual point of view video images of the object are captured.

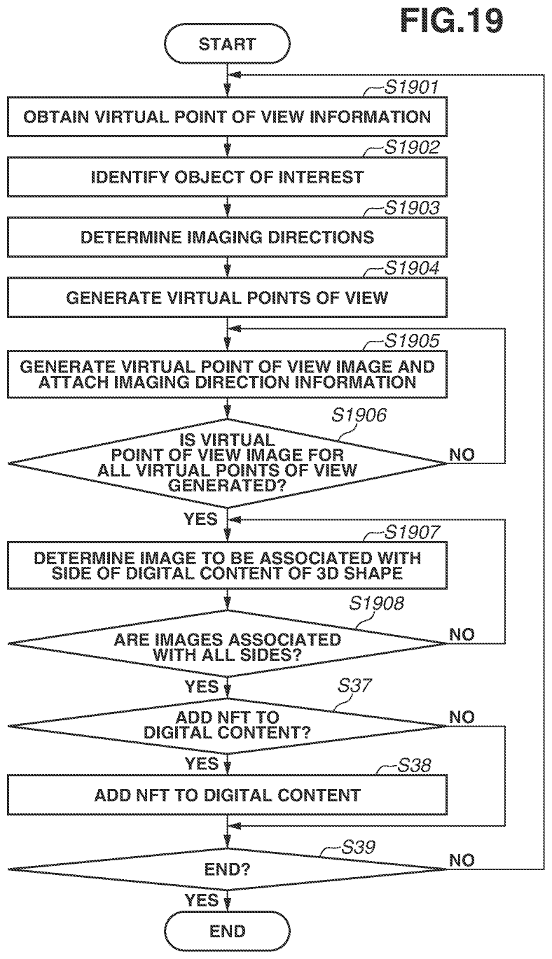

FIG. 19 is a flowchart for describing an operation procedure of the image processing system 101 according to the seventh exemplary embodiment. A procedure similar to that of steps S37 to S39 in FIG. 3 is denoted by the same reference numerals, and a description thereof will be omitted.

In step S1901, the image generation unit 1501 obtains virtual point of view information indicating the position of the virtual point of view specified by the user via the operation unit 116 and the line of sight direction from the virtual point of view.

In step S1902, the image generation unit 1501 identifies an object of interest in the virtual point of view image seen from the virtual point of view corresponding to the obtained virtual point of view information. In the present exemplary embodiment, an object at or closest to the center of the virtual point of view video image is identified.

In step S1903, the image generation unit 1501 determines the imaging directions of the object of interest. In the present exemplary embodiment, a plane orthogonal to a straight line connecting the position of the object of interest and a predetermined position and tangential to the 3D model of the object of interest is determined to be the front side. The imaging directions corresponding to the top, bottom, left, right, and back are determined with reference to the front side.

In step S1904, the image generation unit 1501 generates a plurality of virtual points of view corresponding to the plurality of imaging directions determined in step S1903. In the present exemplary embodiment, the imaging directions corresponding to the front, back, top, bottom, left, and right are determined with respect to the object of interest, and corresponding virtual points of view are generated respectively. The lines of sight directions from the generated virtual points of view can be set to be the same as the imaging directions, and the object of interest does not need to fall on the optical axes from the virtual points of view. The generated virtual points of view are located at positions a predetermined value of distance away from the position of the object of interest. In the present exemplary embodiment, the virtual points of view are set at positions three meters away from the object of interest.

In step S1905, the image generation unit 1501 generates a virtual point of view image corresponding to a generated virtual point of view. The image generation unit 1501 then attaches imaging direction information indicating the imaging direction corresponding to the virtual point of view to the generated virtual point of view image.

In step S1906, the image generation unit 1501 determines whether virtual point of view video images are generated for all the virtual points of view generated in step S1904. If all the virtual point of view video images are generated (YES in step S1906), the image generation unit 1501 transmits the generated virtual point of view video images to the content generation unit 1502, and the processing proceeds to step S1907. If all the virtual point of view video images are not generated (NO in step S1906), the processing proceeds to step S1905 to loop until all the virtual point of view video images are generated.

In step S1907, the content generation unit 1502 associates a received virtual point of view video image with the corresponding side of the digital content of 3D shape based on the imaging direction information about the received virtual point of view video image.

In step S1908, the content generation unit 1502 determines whether the received virtual point of view video images are associated with all the sides of the digital content of 3D shape. If the virtual point of view video images are associated with all the sides (YES in step S1908), the processing proceeds to step S37. If not (NO in step S1908), the processing proceeds to step S1907. In the present exemplary embodiment, all the sides is assumed to be associated with any of the virtual point of view video images. However, this is not restrictive, and the virtual point of view video images may be associated with a specific side or sides. In such a case, whether the virtual point of view video images are associated with the specific side or sides is determined in step S1908.

By such processing, the virtual point of view video images corresponding to the imaging directions can be associated with the respective sides of the digital content of 3D shape. As a result, the user who views the virtual point of view video images using the digital content can intuitively find out the virtual point of view video images corresponding to the respective sides when he/she wants to switch the virtual point of view video images.

In the seventh exemplary embodiment, a plurality of virtual points of view corresponding to the same timecode is generated with reference to a virtual point of view specified by the operator, and virtual point of view video images corresponding to the imaging directions from the respective virtual points of view are associated with the respective sides of the digital content. However, there can be a case where the operator wants to associate the virtual point of view video image seen from the virtual point of view specified by the operator with a side corresponding to the imaging direction. In an eighth exemplary embodiment, an imaging direction in which the virtual point of view video image of the object of interest seen from the virtual point of view specified by the operator is captured is identified, and the virtual point of view video image is associated with a side of the digital content based on the imaging direction.

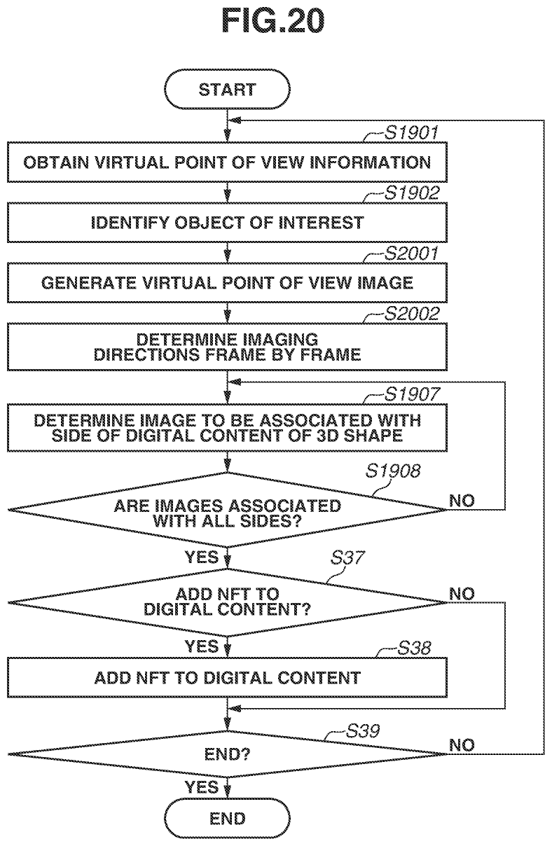

FIG. 20 is a flowchart for describing an operation procedure of an image processing system 101 according to the eighth exemplary embodiment. A processing similar to that of steps S37 to S39 in FIG. 3 and steps S1901, S1902, S1907, and S1908 in FIG. 19 is denoted by the same reference numerals, and a description thereof will be omitted.

In step S2001, the imaging generation unit 1501 generates a virtual point of view video image based on the virtual point of view information obtained in step S1901.

In step S2002, the image generation unit 1501 determines the imaging directions with respect to the object of interest frame by frame of the virtual point of view video image. Suppose, for example, that an entire virtual point of view video image includes 1000 frames, including 800 frames to which the imaging direction information “front side” is attached. The virtual point of view video image also includes 100 frames to which the imaging direction information “rear side” is attached, 50 frames to which the imaging direction information “left side” is attached, 30 frames to which the imaging direction information “right side” is attached, 10 frames to which the imaging direction information “top side” is attached, and 10 frames to which the imaging direction information “bottom side” is attached. The imaging direction information is thus attached in units of frames having different timecodes.

In the present exemplary embodiment, when the user views the digital content, frames of different imaging directions are displayed on respective corresponding sides of the digital content in a rotationally switched manner. This can provide a dynamic virtual point of view video image by taking advantage of the 3D shape.

In the present exemplary embodiment, the sides of the digital content of 3D shape to be associated are determined in advanced in accordance with the imaging directions. However, this is not restrictive. For example, the sides of the digital content of 3D shape to be associated may be determined in descending order of the ratios of the frames of the respective pieces of virtual point of view video image including the object. Specifically, second to sixth directions are set in descending order of the frame ratios. Suppose that 1000 frames of virtual point of view video image includes 800 frames from the front side 1604, 100 frames from the rear side 1605, 50 frames from the left side 1604, 30 frames from the right side 1602, 10 frames from the top side 1603, and 10 frames from the bottom side 1606. In such a case, a first direction is determined to be the front side direction, and the second to sixth directions are determined to be the rear side, left side, right side, top side, and bottom side directions in order. The virtual point of view video image to which the imaging direction information is attached is then output to the content generation unit 1502.

In the fourth exemplary embodiment, the storage unit 5 storing the digital content is described to be built in the image processing apparatus 100. A ninth exemplary embodiment deals with an example of storing the digital content in an external apparatus 2102. An image processing apparatus 102 is the image processing apparatus 100 from which the storage unit 5 is removed (not illustrated).

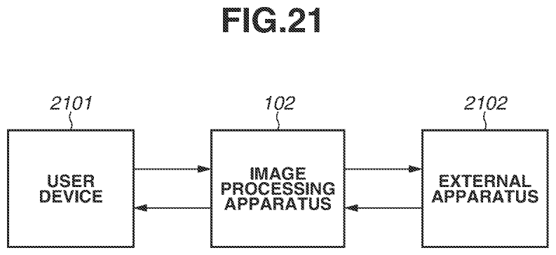

FIG. 21 is a diagram illustrating a system configuration of an image processing system 103 according to the ninth exemplary embodiment. The image processing system 103 includes the image processing apparatus 102, a user device 2101, and the external apparatus 2102.

The image processing apparatus 102 generates digital content by the method described in any one of the first to third exemplary embodiments. Media data such as the generated digital content and the virtual point of view images used for generation, icons representing the virtual point of view images, and metadata on the virtual point of view images are transmitted to the external apparatus 2102. The image processing apparatus 102 also generate display images. The generated display images are transmitted to the user device 2101.

Examples of the user device 2101 may include a PC, a smartphone, and a tablet terminal including a touchscreen (not illustrated). The present exemplary embodiment will be described by using a tablet terminal including a touchscreen as an example.

The external apparatus 2102 stores the digital content generated by the method described in any one of the first to third exemplary embodiments. Like the storage unit 5 in FIG. 1, the external apparatus 2102 also stores virtual point of view images, camera images, and icons corresponding to virtual point of view images to be displayed on each piece of digital content in addition to the digital content. If a specific piece of digital content is requested by the image processing apparatus 102, the external apparatus 2102 transmits the requested digital content to the image processing apparatus 102. Aside from the digital content, the external apparatus 2102 may transmit virtual point of view images and metadata on the virtual point of view images to the image processing apparatus 102.

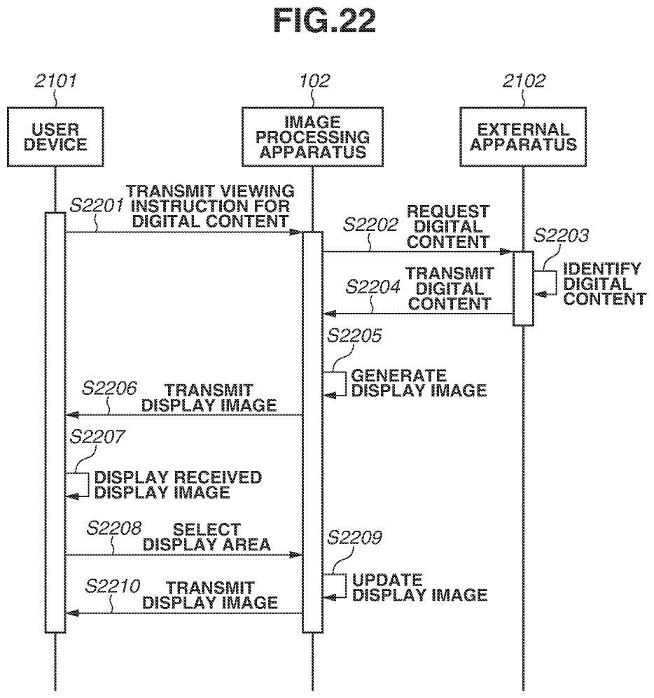

FIG. 22 is a diagram illustrating a data transmission procedure according to the ninth exemplary embodiment. In the present exemplary embodiment, a procedure for generating display images in response to instructions from a user, and switching virtual point of view images to be displayed in accordance with operations made on the display images.

In step S2201, the user device 2101 transmits a viewing instruction for digital content to the image processing apparatus 102 after user's input. This instruction includes information for identifying the digital content to be viewed. Specific examples of the information include an NFT for the digital content and an address where the digital content is stored in the external apparatus 2102.

In step S2202, the image processing apparatus 102 requests the digital content to be viewed based on the obtained viewing instruction from the external apparatus 2102.

In step S2203, the external apparatus 2102 identifies the digital content corresponding to the obtained request. Depending on the requested content, the external apparatus 2102 identifies not only the digital content but also metadata on the digital content and related virtual point of view images.

In step S2204, the external apparatus 2102 transmits the identified digital content to the image processing apparatus 102. If there is identified information other than the digital content, the external apparatus 2102 transmits the other identified information as well.

In step S2205, the image processing apparatus 102 generates display images corresponding to the obtained digital content. For example, if three virtual point of view video images are associated with the obtained digital content, the image processing apparatus 102 generates the display images illustrated in FIG. 9 according to the fourth exemplary embodiment. Alternatively, the display images illustrated in FIG. 11 according to the fifth exemplary embodiment or those illustrated in FIG. 13 according to the sixth exemplary embodiment may be generated. In the present exemplary embodiment, the display images illustrated in FIG. 9 according to the fourth exemplary embodiment are preset as the ones to be generated. Alternatively, display images corresponding to the digital content may be set in advance. In such a case, the creator of the digital content sets the display images in generating the digital content, and stores the display images into metadata on the digital content. As another example, display images generated by the user may be set. In such a case, the image processing apparatus 102 specifies the types of display images to be displayed in issuing the viewing instruction for the digital content in step S2201. The image processing apparatus 102 then associates the generated display images with the respective sides of the digital content. In the present exemplary embodiment, the object is a basketball player, and the first display area 901 displays an image corresponding to a main image showing the player. The second display area 902 displays an image showing three virtual point of view video images related to the player in the main image and an icon 913 representing a virtual point of view image in a superimposed manner. The third display area 903 displays an image indicating information about a team to which the player displayed in the main image is affiliated. The fourth display area 904 displays an image indicating record information about the player displayed in the main image in the season when the main image is captured. The fifth display area 905 displays an image indicating the final score of the game where the images are captured. The sixth display 906 displays an image indicating copyright information about the digital content. The images in the first to sixth display areas 901 to 906 can be selected by user operations. In step S2205, the image processing apparatus 102 displays the main image showing the player displayed in the first display area 901 in the seventh display area 907 as an initial image.

In step S2206, the image processing apparatus 102 transmits the display images generated in step S2205 to the user device 2101.

In step S2207, the user device 2101 displays the received display images.

In step S2208, if a user operation to select a display area of a display image is received, the user device 2101 transmits information for specifying the selected display area to the image processing apparatus 102. For example, if the display images illustrated in FIG. 9 of the fourth exemplary embodiment are displayed and the user selects the image corresponding to the display area 902, the user device 2101 transmits information indicating that the display area 902 is selected to the image processing apparatus 102. In the present exemplary embodiment, the information for specifying the display area is transmitted to the image processing apparatus 102 in order that an image or video image different from those displayed in the first to the sixth display area 906 can be displayed in the seventh display area 907. However, this is not restrictive, and the image selected by the user operation may be displayed in the seventh display area 907. In such a case, information indicating the selected image is transmitted to the image processing apparatus 102 instead of the information indicating the selected display area.

In step S2209, the image processing apparatus 102 determines which image of the digital content is selected from the icon corresponding to the selected display part. In the example of S2208, since the user selected the display area 902, the virtual viewpoint image corresponding to the display area 902 was selected. Therefore, the virtual viewpoint image included in the digital content is displayed in the seventh display area 907. When multiple virtual viewpoint images are included in the digital content, the first virtual viewpoint image to be displayed is set in advance. Through the above processing, the information specifying the display area corresponding to the image selected by the user operation among the first display area 901 to the sixth display area 906 is received, and the display screen is updated by displaying the image or video corresponding to the selected display area in the seventh display area 907. When multiple virtual viewpoint images are displayed in the second area 1308, as in the display screen shown in FIG. 13 of the sixth embodiment, it is determined whether touch input or flick input for the displayed virtual viewpoint images has been received. When touch input is received, the virtual viewpoint video being played is paused. When flick input is received, the virtual viewpoint image displayed in the fifth display area 1305 and currently being played is switched to a different virtual viewpoint image.

In step S2210, the image processing apparatus 102 transmits the updated display images to the user device 2101.

By such processing, display images for displaying the user-desired digital content can be generated and displayed on the user device 2101.

While several exemplary embodiments of the present disclosure have been described in detail above, the present disclosure is not limited to the foregoing exemplary embodiments. Various modifications can be made based on the gist of the present disclosure, and such modifications are not excluded from the scope of the present disclosure. For example, the foregoing first to nine exemplary embodiments can be combined as appropriate. According to an exemplary embodiment of the present disclosure, attractive digital content including a virtual point of view image or images and other images can be displayed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

To implement part or all of control according to an exemplary embodiment of the present disclosure, a computer program for implementing the functions of the foregoing exemplary embodiments may be supplied to an image processing system via a network or various storage media. The program then may be read and executed by a computer (or CPU or microprocessing unit [MPU]) of the image processing system. In such a case, the program and the storage medium storing the program constitute the present exemplary embodiment.

The present exemplary embodiment includes the following configurations, method, and program.

### (Configuration 1)

An apparatus including
an identification unit configured to identify a virtual point of view image associated with a first side of digital content of three-dimensional shape and an image from a point of view different from a virtual point of view corresponding to the virtual point of view image, the image being associated with a second side of the digital content, the virtual point of view image being generated based on a plurality of images captured by a plurality of imaging apparatuses and the virtual point of view, and
a display control unit configured to control display of an image corresponding to the virtual point of view image and an image corresponding to the image from the point of view different from the virtual point of view in a display area.

### (Configuration 2)

The apparatus according to configuration 1, further including an obtaining unit configured to obtain input information to select the display area,
wherein the display control unit is configured to display an image corresponding to the selected display area in a selection display area based on the input information obtained by the obtaining unit, the selection display area being a display area different from the selected display area.

### (Configuration 3)

The apparatus according to configuration 1 or 2, wherein the digital content includes a plurality of virtual point of view images generated based on the plurality of images and a plurality of virtual points of view including the virtual point of view.

### (Configuration 4)

The apparatus according to any one of configurations 1 to 3, wherein the display control unit is configured to display images corresponding to a/the plurality of virtual point of view images in respective different display areas.

### (Configuration 5)

The apparatus according to any one of configurations 1 to 4,
wherein an image corresponding to a/the plurality of virtual point of view images is associated with a specific display area, and
wherein the display control unit is configured to, in a case where an input to select a display area to display the image corresponding to the plurality of virtual point of view images is obtained by the obtaining unit, display a specific virtual point of view image among the plurality of virtual point of view images in a/the selection display area.

### (Configuration 6)

The apparatus according to any one of configurations 1 to 5, wherein at least one virtual point of view among a/the plurality of virtual points of view corresponding to a/the plurality of virtual point of view images is determined based on an object included in at least one image among the plurality of images captured by the plurality of imaging apparatuses.

### (Configuration 7)

The apparatus according to any one of configurations 1 to 6, wherein a position of the virtual point of view is determined based on a position of a three-dimensional shape representing an/the object.

### (Configuration 8)

The apparatus according to any one of configurations 1 to 7, wherein a position of at least one virtual point of view among a/the plurality of virtual points of view corresponding to a/the plurality of virtual point of view images is determined based on a position of an/the object, and a line of sight direction from the virtual point of view is determined based on a direction of the object.

### (Configuration 9)

The apparatus according to any one of configurations 1 to 7, wherein a position of at least one virtual point of view among a/the plurality of virtual points of view corresponding to a/the plurality of virtual point of view images is determined based on a position a predetermined distance behind an/the object, and a line of sight direction from the virtual point of view is determined based on a direction of the object.

### (Configuration 10)

The apparatus according to any one of configurations 1 to 7, wherein a position of at least one virtual point of view among a/the plurality of virtual points of view corresponding to a/the plurality of virtual point of view images is determined on a position on a spherical surface about an/the object, and a line of sight direction from the virtual point of view is determined based on a direction from the position of the virtual point of view to the object.

### (Configuration 11)

The apparatus according to any one of configurations 1 to 8,
wherein an/the object is a human figure, and
wherein a/the direction of the object is a direction of an object's face.

### (Configuration 12)

The apparatus according to any one of configurations 1 to 5, wherein the display control unit is configured to, in a case where specific operation information is input to a/the selection display area, switch a/the virtual point of view image displayed in the selection display area and a virtual point of view image different from the virtual point of view image displayed in the selection display area among a/the plurality of virtual point of view images.

### (Configuration 13)

The apparatus according to configuration 12, wherein the specific operation information is operation information about at least one of a keyboard typing operation, a mouse click operation, a mouse scroll operation, and a touch operation, a slide operation, a flick gesture, a pinch-in operation, and a pinch-out operation on a display device displaying the virtual point of view image.

### (Configuration 14)

The apparatus according to configuration 12, wherein the display control unit is configured to superimpose icons corresponding to the plurality of respective virtual point of view images on the selection display area, and in a case where an input to select any one of the icons is accepted, switch the virtual point of view image displayed in the selection display area and the virtual point of view image corresponding to the selected icon.

### (Configuration 15)

The apparatus according to any one of configurations 1 to 14, wherein the display control unit is configured to superimpose an icon representing the virtual point of view image on an image indicating the virtual point of view image.

### (Method 1)

An image processing method including
identifying a virtual point of view image associated with a first side of digital content of three-dimensional shape and an image from a point of view different from a virtual point of view corresponding to the virtual point of view image, the image being associated with a second side of the digital content, the virtual point of view image being generated based on a plurality of images captured by a plurality of imaging apparatuses and the virtual point of view, and
controlling display of an image corresponding to the virtual point of view image and an image corresponding to the image from the point of view different from the virtual point of view in a display area.

### (Program)

A storage medium storing a program for causing a computer to control the units of the apparatus according to any one of configurations 1 to 15.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2022-073894, filed Apr. 27, 2022, and No. 2023-038750, filed Mar. 13, 2023, which are hereby incorporated by reference herein in their entirety.

What is claimed is:

1. An image processing system comprising:
an identification unit configured to identify a virtual point of view image associated with a first side of digital content of three-dimensional shape and an image from a point of view different from a virtual point of view corresponding to the virtual point of view image, the image being associated with a second side of the digital content, the virtual point of view image being generated based on a plurality of images captured by a plurality of imaging apparatuses and the virtual point of view; and
a display control unit configured to control display of an image corresponding to the virtual point of view image and an image corresponding to the image from the point of view different from the virtual point of view in a display area.

2. The image processing system according to claim 1, further comprising an obtaining unit configured to obtain input information to select the display area,
wherein the display control unit is configured to display an image corresponding to the selected display area in a selection display area based on the input information obtained by the obtaining unit, the selection display area being a display area different from the selected display area.

3. The image processing system according to claim 2, wherein the digital content includes a plurality of virtual point of view images generated based on the plurality of images and a plurality of virtual points of view including the virtual point of view.

4. The image processing system according to claim 3, wherein the display control unit is configured to display images corresponding to the plurality of virtual point of view images in respective different display areas.

5. The image processing system according to claim 3,
wherein an image corresponding to the plurality of virtual point of view images is associated with a specific display area, and
wherein the display control unit is configured to, in a case where an input to select a display area to display the image corresponding to the plurality of virtual point of view images is obtained by the obtaining unit, display a specific virtual point of view image among the plurality of virtual point of view images in the selection display area.

6. The image processing system according to claim 5, wherein at least one virtual point of view among the plurality of virtual points of view corresponding to the plurality of virtual point of view images is determined based on an object included in at least one image among the plurality of images captured by the plurality of imaging apparatuses.

7. The image processing system according to claim 6, wherein a position of the virtual point of view is determined based on a position of a three-dimensional shape representing the object.

8. The image processing system according to claim 3, wherein a position of at least one virtual point of view among the plurality of virtual points of view corresponding to the plurality of virtual point of view images is determined based on a position of an object, and a line of sight direction from the virtual point of view is determined based on a direction of the object.

9. The image processing system according to claim 3, wherein a position of at least one virtual point of view among the plurality of virtual points of view corresponding to the plurality of virtual point of view images is determined based on a position a predetermined distance behind an object, and a line of sight direction from the virtual point of view is determined based on a direction of the object.

10. The image processing system according to claim 3, wherein a position of at least one virtual point of view among the plurality of virtual points of view corresponding to the plurality of virtual point of view images is determined on a position on a spherical surface about an object, and a line of sight direction from the virtual point of view is determined based on a direction from the position of the virtual point of view to the object.

11. The image processing system according to claim 8,
wherein the object is a human figure, and
wherein the direction of the object is a direction of an object's face.

12. The image processing system according to claim 5, wherein the display control unit is configured to, in a case where specific operation information is input to the selection display area, switch the virtual point of view image displayed in the selection display area and a virtual point of view image different from the virtual point of view image displayed in the selection display area among the plurality of virtual point of view images.

13. The image processing system according to claim 12, wherein the specific operation information is operation information about at least one of: a keyboard typing operation, a mouse click operation, a mouse scroll operation, and a touch operation, a slide operation, a flick gesture, a pinch-in operation, and a pinch-out operation on a display device displaying the virtual point of view image.

14. The image processing system according to claim 12, wherein the display control unit is configured to superimpose icons corresponding to the plurality of respective virtual point of view images on the selection display area, and in a case where an input to select any one of the icons is accepted, switch the virtual point of view image displayed in the selection display area and the virtual point of view image corresponding to the selected icon.

15. The image processing system according to claim 1, wherein the display control unit is configured to superimpose an icon representing the virtual point of view image on an image indicating the virtual point of view image.

16. An image processing method comprising:
identifying a virtual point of view image associated with a first side of digital content of three-dimensional shape and an image from a point of view different from a virtual point of view corresponding to the virtual point of view image, the image being associated with a second side of the digital content, the virtual point of view image being generated based on a plurality of images captured by a plurality of imaging apparatuses and the virtual point of view; and
controlling display of an image corresponding to the virtual point of view image and an image corresponding to the image from the point of view different from the virtual point of view in a display area.

17. A storage medium storing a computer program for causing a computer to control the units of the image processing system according to claim 1.
